(19) United States
(12) Patent Application Publication
(10) Pub. No.: US 2018/0006584 A1
(43) Pub. Date: Jan. 4, 2018

(54) PIEZOELECTRIC ACTUATOR APPARATUS AND CONTROL METHOD THEREFOR

(71) Applicant: Sony Corporation, Tokyo (JP)

(72) Inventors: Yu Nishimura, Tokyo (JP); Toshiaki Edamitsu, Tokyo (JP); Hitoshi Yamagata, Saitama (JP)

(21) Appl. No.: 15/545,118

(22) PCT Filed: Nov. 30, 2015
(86) PCT No.: PCT/JP2015/083667

§ 371 Date: Jul. 20, 2017

(30) Foreign Application Priority Data
Mar. 2, 2015 (JP) 2015-040732

(51) Int. Cl. H02N 2/02; G02B 7/04; G03B 3/10; H02N 2/06

(52) U.S. Cl. CPC H02N 2/025; H02N 2/067; G02B 7/04; G03B 3/10; G03B 2205/0061

(57) ABSTRACT

There is provided a piezoelectric actuator apparatus capable of moving an object to be driven at high velocity by using a piezoelectric element to apply a force to a driving member coupled to the object to be driven by a predetermined frictional force.

A piezoelectric actuator apparatus 100 is controlled and driven by inputting a driving voltage having a PWM waveform to a piezoelectric element 101 to which an inductor 27 and a resistor 28 are connected in series. The piezoelectric actuator apparatus 100 increases the velocity of the object to be driven 106 by adjusting respective values of the inductance L₀ and the resistance R₀ to control damping ratios, amplitudes, and resonance frequencies of the respective vibrations of the piezoelectric mechanical resonance and the piezoelectric electrical resonance, and inducing a response of the driving member 102 closer to sawtooth waves.

### TECHNICAL FIELD

A technology disclosed in the present specification relates to a piezoelectric actuator apparatus and a control method therefor that moves an object to be driven by using a piezoelectric element, and particularly, to a piezoelectric actuator apparatus and a control method therefor that drives a driving member with a piezoelectric element and moves an object to be driven which is coupled to the driving member by a predetermined frictional force.

### BACKGROUND ART

A driving apparatus including an impact-type piezoelectric actuator is known. The impact-type piezoelectric actuator has a configuration in which an engagement member to which a photographing lens or the like is attached is coupled to a rod-like driving member so as to have a predetermined frictional force, and a piezoelectric element is fixed to one end of the driving member. A proposal has also been made on a method for driving by applying a rectangular-wave voltage to this kind of impact-type piezoelectric actuator (for example, see Patent Document 1)

### CITATION LIST

### Patent Document

Patent Document 1: Japanese Patent Application Laid-Open No. 2001-268951

### SUMMARY OF THE INVENTION

### Problems to be Solved by the Invention

An object of the technology disclosed in the present specification is to provide a superior piezoelectric actuator apparatus and a control method therefor that can drive a driving member with a piezoelectric element and suitably move an object to be driven which is coupled to the driving member by a predetermined frictional force.

### Solutions to Problems

The technology disclosed in the present specification has been made in view of the aforementioned problems, and a first aspect thereof is a piezoelectric actuator apparatus including:

a series connection body in which a piezoelectric element, an inductor, and an electrical resistor are connected in series;

a driving circuit configured to apply a rectangular-wave driving voltage to the series connection body; and

a driving member configured to be driven by the piezoelectric element and couple an object to be driven by a predetermined frictional force.

According to a second aspect of the technology disclosed in the present specification, the piezoelectric actuator apparatus according to the first aspect is configured in such a way that due to a piezoelectric effect of the piezoelectric element, displacement of the driving member with respect to the driving voltage is governed by a fourth-order differential equation, and a first resonance phenomenon and a second resonance phenomenon derived from the fourth-order differential equation are used for driving.

According to a third aspect of the technology disclosed in the present specification, in the piezoelectric actuator apparatus according to the second aspect, the first resonance phenomenon is a piezoelectric mechanical resonance mainly including a mechanical resonance of the piezoelectric actuator apparatus with respect to the driving by the piezoelectric element and receiving an electrical influence of the series connection body due to the piezoelectric effect of the piezoelectric element. Furthermore, the second resonance phenomenon is a piezoelectric electrical resonance mainly including an electrical resonance and receiving an influence of mechanical vibration of the driving member due to the piezoelectric effect of the piezoelectric element.

According to a fourth aspect of the technology disclosed in the present specification, in the piezoelectric actuator apparatus according to the second aspect or the third aspect, the first resonance phenomenon has a resonance frequency mainly including a mechanical resonance frequency of a two-mass system defined on the basis of an equivalent spring constant determined from a physical property value of the piezoelectric element and a mass of the driving member, and configured to be decreased in receiving the electrical influence due to the piezoelectric effect of the piezoelectric element. Furthermore, the second resonance phenomenon has a resonance frequency mainly including an electrical resonance frequency of an LCR circuit defined on the basis of the inductor, the electrical resistor, and a capacitance determined from the physical property value of the piezoelectric element, and configured to be increased in receiving the mechanical influence due to the piezoelectric effect of the piezoelectric element.

According to a fifth aspect of the technology disclosed in the present specification, in the piezoelectric actuator apparatus according to any one of the first aspect to the fourth aspect, an inductance value of the inductor and a resistance value of the electrical resistor are determined so that the resonance frequencies of the first resonance phenomenon and the second resonance phenomenon and damping ratios of resonance vibrations each become desired values.

According to a sixth aspect of the technology disclosed in the present specification, in the piezoelectric actuator apparatus according to any one of the first aspect to the fifth aspect, the inductance value of the inductor and the resistance value of the electrical resistor are determined on the basis of an actual measured value of an impedance characteristic of a driving unit including the piezoelectric element, the driving member, and the object to be driven when the desired first resonance phenomenon and the second resonance phenomenon are obtained.

According to a seventh aspect of the technology disclosed in the present specification, in the piezoelectric actuator apparatus according to the third aspect, the inductance value of the inductor and the resistance value of the electrical resistor for making each of the piezoelectric mechanical resonance vibration and the piezoelectric electrical resonance vibration a desired resonance frequency are determined so as to induce a desired sawtooth wave displacement of the driving member with respect to the application of the rectangular-wave driving voltage by superposing the piezoelectric mechanical resonance vibration and the piezoelectric electrical resonance vibration.

According to an eighth aspect of the technology disclosed in the present specification, the piezoelectric actuator apparatus according to the third aspect or the seventh aspect is configured such that a ratio between the resonance frequency of the piezoelectric mechanical resonance vibration and the resonance frequency of the piezoelectric electrical resonance vibration is in a range of 1.5 to 3.

According to a ninth aspect of the technology disclosed in the present specification, the piezoelectric actuator apparatus according to the third aspect or the seventh aspect is configured such that a ratio between the resonance frequency of the piezoelectric mechanical resonance vibration and a driving frequency of the rectangular-wave driving voltage is in a range of 1 to 1.5.

According to a tenth aspect of the technology disclosed in the present specification, the piezoelectric actuator apparatus according to any one of the third aspect and the seventh aspect to the ninth aspect is configured such that a ratio between the resonance frequency of the piezoelectric electrical resonance vibration and the driving frequency of the rectangular-wave driving voltage is in a range of 1.5 to 4.5.

Furthermore, an eleventh aspect of the technology disclosed in the present specification is a control method for a piezoelectric actuator apparatus configured to apply a rectangular-wave driving voltage to a series connection body in which a piezoelectric element, an inductor, and an electrical resistor are connected in series, and drive a driving member by the piezoelectric element, the driving member coupling an object to be driven by a predetermined frictional force, the control method including:

a control step of controlling a rectangular-wave driving frequency of the driving voltage on the basis of one main resonance frequency out of two resonance phenomena derived from a fourth-order differential equation, the fourth-order differential equation governing displacement of the driving member with respect to the driving voltage due to a piezoelectric effect of the piezoelectric element.

According to a twelfth aspect of the technology disclosed in the present specification, in the control step of the control method for the piezoelectric actuator apparatus according to the eleventh aspect, resonance between the rectangular-wave driving frequency and another resonance vibration of the two resonance phenomena derived from the fourth-order differential equation is configured to be avoided.

### Effects of the Invention

According to the technology disclosed in the present specification, it is possible to provide a superior piezoelectric actuator apparatus and a control method therefor that can displace a driving member with optimal sawtooth waves using a piezoelectric element and move an object to be driven at high velocity which is coupled to the driving member by a predetermined frictional force.

Note that the effects described in the present specification are merely exemplifications, and the effects of the present invention are not limited thereto. Furthermore, in some cases, the present invention may also exhibit further additional effects other than the effects described above.

Other additional objects, features, and advantages of an embodiment of the technology disclosed in the present specification will be clarified by more detailed description based on the embodiment described later and the accompanying drawings.

### BRIEF DESCRIPTION OF DRAWINGS

FIG. 1 is a diagram schematically illustrating an exemplary configuration of a piezoelectric actuator apparatus 100 to which a technology disclosed in the present specification can be applied.

FIG. 2 is a diagram illustrating an exemplary configuration of a driving circuit 104.

FIG. 3 is a diagram illustrating a mechanical model of the piezoelectric actuator apparatus 100 illustrated in FIG. 1.

FIGS. 4A(A) to (C) are diagrams illustrating an ideal sawtooth wave displacement of a driving member 102, a velocity v₁₀₂ of the driving member 102, and a frictional force μN exerted on an object to be driven 106.

FIGS. 4B(A) and (B) are diagrams illustrating velocity waveforms of the driving member in a case where the driving member 102 is not displaced with the ideal sawtooth waves.

FIGS. 5(A) and (B) are diagrams illustrating actual displacement x₁₀₂ and velocity v₁₀₂ of the driving member 102 when a voltage of a PWM waveform is applied to a piezoelectric element 101.

FIG. 6 is a diagram illustrating a driving circuit 104′ according to another exemplary configuration that inputs a driving voltage to the piezoelectric element 101.

FIG. 7 is a diagram illustrating a mechanical model of a piezoelectric actuator apparatus 700 using the driving circuit 104′ illustrated in FIG. 6.

FIG. 8 is a diagram exemplifying a frequency response of a transfer function.

FIG. 9 is a diagram exemplifying a comparison between an actual measured value of an impedance characteristic of a driving unit 107 and a system including a frequency response obtained as an analytical solution.

FIGS. 10(A) and (B) are diagrams illustrating a step response of the piezoelectric actuator apparatus 700.

FIGS. 11(A) and (B) are diagrams illustrating waveforms of the position and velocity of the driving member 102 in the piezoelectric actuator apparatus 700 in the case of using the driving circuit 104′ illustrated in FIG. 6.

FIGS. 12(A) and (B) are diagrams illustrating waveforms of the position and velocity of the driving member 102 in the piezoelectric actuator apparatus 100 in the case of using the driving circuit 104 illustrated in FIG. 2.

FIGS. 13(A) and (B) are diagrams illustrating waveforms of the position and velocity of the driving member 102 in a case where a velocity decrease of a piezoelectric mechanical resonance component cannot be canceled because a frequency of a piezoelectric electrical resonance component is not matched.

FIGS. 14(A) and (B) are diagrams illustrating waveforms of the position and the velocity of the driving member 102 in the case of occurrence of the velocity decrease due to an influence of a too large amplitude of the piezoelectric electrical resonance component.

FIGS. 15(A) and (B) are diagrams illustrating examples of the step response and the velocity of the piezoelectric actuator apparatus 700 illustrated in FIG. 7, which are decomposed into components of the piezoelectric mechanical resonance vibration and the piezoelectric electrical resonance vibration.

FIGS. 16(A) and (B) are diagrams illustrating a piezoelectric mechanical resonance frequency and a piezoelectric electrical resonance frequency with an inductance L₀ of an inductor 27 and a ratio between the piezoelectric mechanical resonance frequency and the piezoelectric electrical resonance frequency.

FIG. 17 is a diagram illustrating a result of the Fourier transform of a PWM voltage.

FIG. 18 is a diagram illustrating a relationship among a duty ratio, a ratio between an amplitude ψ₁ of the piezoelectric mechanical resonance and an amplitude ψ₂ of the piezoelectric electrical resonance, and the frequencies.

### MODE FOR CARRYING OUT THE INVENTION

Hereinafter, an embodiment of the technology disclosed in the present specification will be described in detail with reference to the drawings.

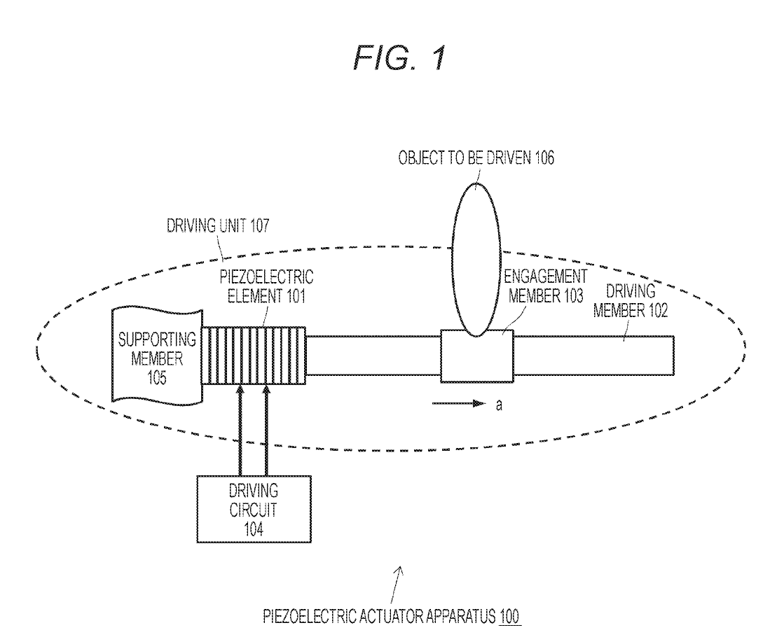

FIG. 1 schematically illustrates an exemplary configuration of a piezoelectric actuator apparatus 100 to which the technology disclosed in the present specification can be applied.

The illustrated piezoelectric actuator apparatus 100 includes a piezoelectric element 101, a driving member 102, an engagement member 103, and a driving circuit 104. The piezoelectric element 101 is an electromechanical conversion element. The driving member 102 is rod-shaped and driven by the piezoelectric element 101. The engagement member 103 is coupled to the driving member 102 by a predetermined frictional force. The driving circuit 104 applies a driving voltage to the piezoelectric element 101.

The piezoelectric element 101 has actions to expand and contract in accordance with the driving voltage applied by the driving circuit 104. One end of the piezoelectric element 101 in the expansion and contraction direction thereof is fixed to a supporting member 105, while the other end is fixed to one end of the rod-like driving member 102 in the longitudinal direction. The absolute position of the supporting member 105 is fixed. An object to be driven 106 is fixed to the engagement member 103 in a predetermined position. The engagement member 103 is movable on the driving member 102 along the longitudinal direction (direction a in FIG. 1). The supporting member 105, the piezoelectric element 101, and the driving member 102 constitute a driving unit 107.

When the piezoelectric element 101 expands and contracts, the driving member 102 moves in the longitudinal direction. The object to be driven 106 which is fixed to the engagement member 103 can be relatively moved to the driving member 102 by using a difference in frictional force generated between the driving member 102 and the engagement member 103 as the driving member 102 is moved at different velocities along the longitudinal direction. That is, the frictional force between the engagement member 103 and the driving member 102 decreases when the driving member 102 moves at high velocity, and the frictional force increases when the driving member 102 moves at low velocity. Therefore, by moving the driving member 102 in the positive direction (direction a in FIG. 1) at low velocity and in the reverse direction at high velocity, the object to be driven 106 can be moved with respect to the driving member 102 in the positive direction (driving in the positive direction). Furthermore, by moving the driving member 102 in the positive direction at high velocity and in the reverse direction at low velocity, the object to be driven 106 can be moved with respect to the driving member 102 in the reverse direction (driving in the reverse direction).

In short, the operation principle of the piezoelectric actuator apparatus 100 is to move the object to be driven 106 by displacing the driving member 102 in the shape of sawtooth waves of high velocity and low velocity through the expansion and contraction actions of the piezoelectric element 101.

To displace the driving member 102 in the shape of the sawtooth waves of high velocity and low velocity, a switching circuit is used as the driving circuit 104. The switching circuit can input a driving voltage of a pulse width modulation (PWM) waveform having a rectangular wave to the piezoelectric element 101.

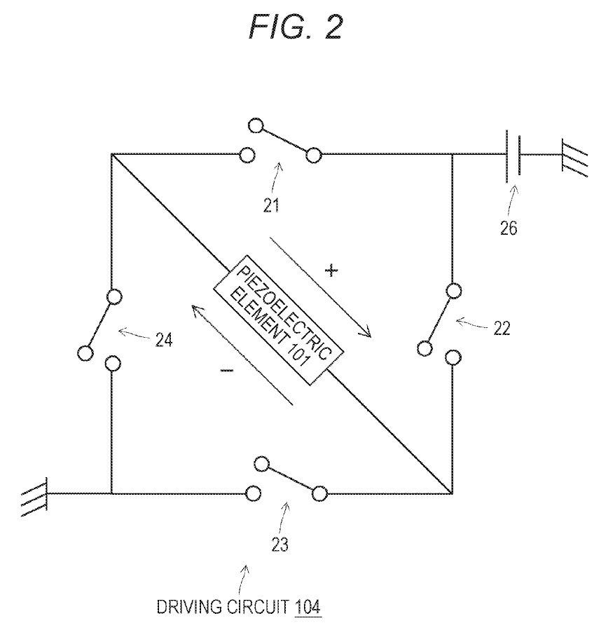

FIG. 2 schematically illustrates an exemplary configuration of the driving circuit 104 that inputs the driving voltage of the PWM waveform to the piezoelectric element 101. The illustrated driving circuit 104 includes a power supply 26 and switches 21 to 24. The power supply 26 outputs a constant voltage. A circuit in which the switch 21 and the switch 24 are connected in series and a circuit in which the switch 22 and the switch 23 are connected in series are connected in parallel between the power supply 26 and a ground. Furthermore, the piezoelectric element 101 is loaded between the switch 21 and the switch 22.

When the switch 21 and the switch 23 are turned on, and at the same time, the switch 22 and the switch 24 are turned off, a voltage in the + direction in FIG. 2 is applied to the piezoelectric element 101. Furthermore, when the switch 21 and the switch 23 are turned off, and at the same time, the switch 22 and the switch 24 are turned on, a voltage in the − direction in FIG. 2 is applied to the piezoelectric element 101. By repeating such on and off operations of the switches 21 to 24 at a certain constant frequency (driving frequency), it is possible to realize the periodic application of the PWM voltage to the piezoelectric element 101. A driving control circuit which is not illustrated controls the switching operations of the switches 21 to 24.

By using a resonance frequency of the driving unit 107 (described above), the driving circuit 104 illustrated in FIG. 2 adjusts the driving frequency of the PWM voltage waveform applied to the piezoelectric element 101, whereby the sawtooth wave displacement of the driving member 102 can be induced. Such a driving circuit 104 has the following advantages (a) and (b).

(a) Weight reduction and miniaturization can be achieved with a simple circuit configuration.

(b) The velocity of the driving member 102 (the object to be driven 106) can be easily controlled by changing the duty ratio.

The driving principle of the piezoelectric actuator apparatus 100 using the driving circuit illustrated in FIG. 2 will be described in more detail.

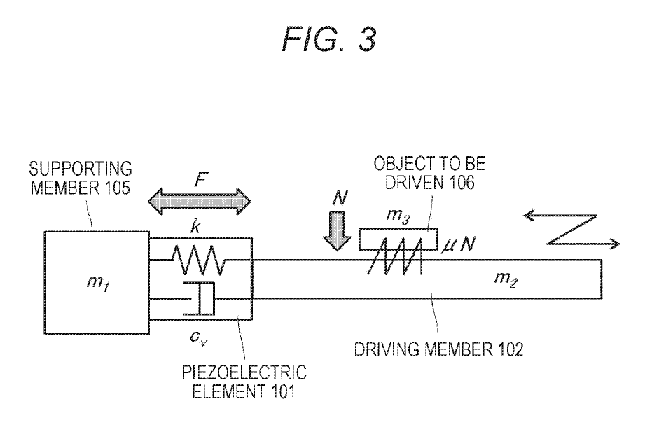

FIG. 3 illustrates a mechanical model of the piezoelectric actuator apparatus 100 using the driving circuit 104 illustrated in FIG. 2. The definition of each physical property is also described in this figure. m₁ is the mass of the supporting member 105. m₂ is the mass of the driving member 102. m₃ is the mass of the object to be driven 106. k is a spring constant of the piezoelectric element 101. cᵥ is a damping coefficient of the piezoelectric element 101. F is a force. N is a pushing force of the engagement member 103. μ is a coefficient of friction of the driving member 102 and the engagement member 103. Therefore, μN is a frictional force.

As illustrated in FIG. 3, the piezoelectric element 101 can be assumed to be of a spring-damper type having the spring constant k and the damping coefficient cᵥ. In this case, an equation of motion governing the driving member 102 is as indicated in the following equation (1). Note that F₀ is a generative force of the piezoelectric element 101. x₁₀₂ is the position of the driving member 102. a₁₀₂ is the acceleration of the driving member 102. χ is a condition of the sign of the frictional force.

[Math. 1]

F₀=kx₁₀₂+cᵥv₁₀₂+m₂a₁₀₂+χ·μN (1)

Furthermore, the equation of motion governing the object to be driven 106 is as indicated in the following equation (2). Note that a₁₀₆ is the acceleration of the object to be driven 106.

[Math. 2]

m₃a₁₀₆=χ·μN (2)

The condition χ of the sign of the frictional force in each of the equations (1) and (2) described above is as indicated in the following equation (3). Note that v₁₀₂ is the velocity of the driving member 102, and v₁₀₆ is the velocity of the object to be driven 106.

$$\begin{matrix}[ Math . 3 ] & \\ χ = \{ \begin{matrix}- 1 , & {v}_{102} - {v}_{106} < 0 \\ 1 , & {v}_{102} - {v}_{106} \geq 0\end{matrix} & ( 3 )\end{matrix}$$

As indicated in the above equation (3), the frictional force corresponding to the velocity difference between the driving member 102 and the object to be driven 106 acts on the object to be driven 106.

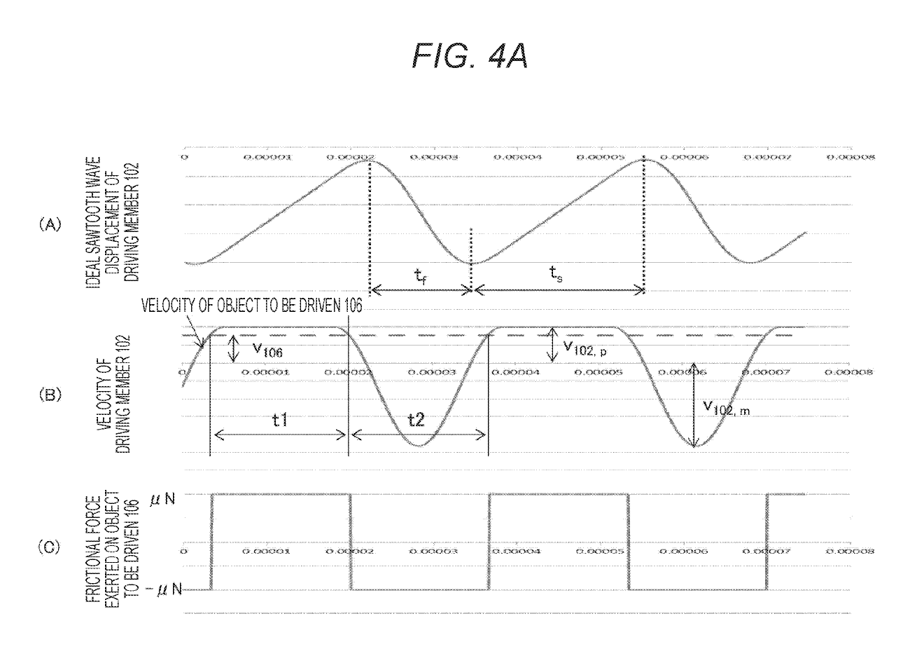

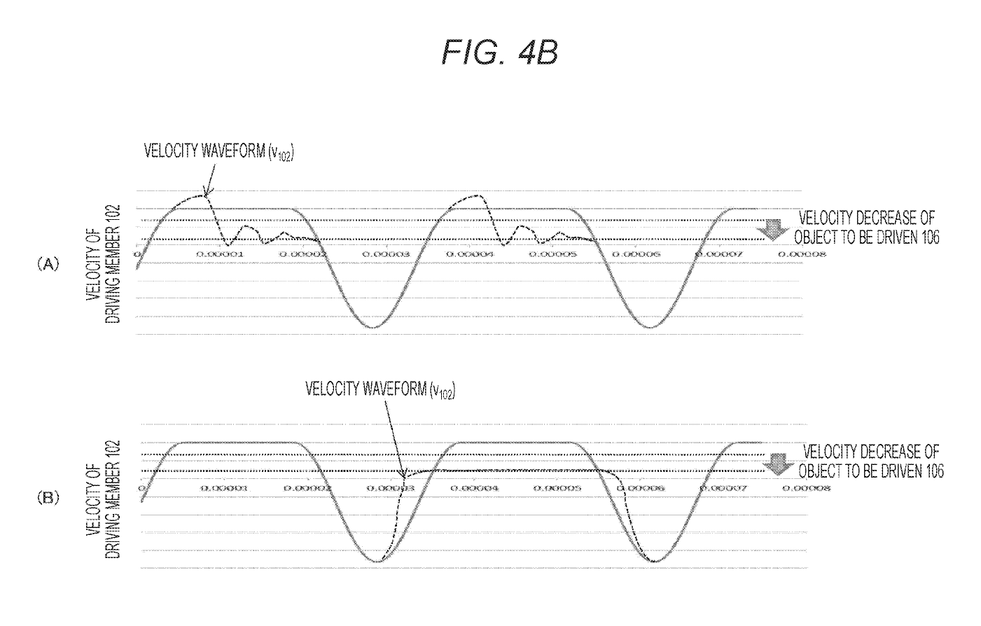

FIG. 4A(A) illustrates an ideal sawtooth wave displacement of the driving member 102. The sawtooth wave displacement has a time t_{f} during which the driving member 102 is moving fast and a time tₛ during which the driving member 102 is moving slowly. Furthermore, FIGS. 4A(B) and (C) illustrate the velocity v₁₀₂ of the driving member 102 and the frictional force μN exerted on the object to be driven 106 during this time, respectively.

As illustrated in FIG. 4A(A), when the driving member 102 moves with the ideal sawtooth waves, the frictional force μN is exerted on the object to be driven 106. In a case where the velocity v₁₀₆ of the object to be driven 106 is lower than the velocity v₁₀₂ of the driving member 102, the frictional force μN is exerted on the object to be driven 106 in a direction following the velocity of the driving member 102. On the other hand, the frictional force μN becomes a load to the driving member 102.

As illustrated in FIG. 4A(A), the driving member 102 is displaced with the sawtooth waves. Thus, when the movement of the object to be driven 106 reaches a certain velocity, the velocity v₁₀₆ of the object to be driven 106 this time conversely becomes higher than the velocity v₁₀₂ of the driving member 102. Accordingly, the direction that the frictional force μN is exerted on is reversed.

When the sawtooth wave displacement of the driving member 102 is repeated in this way, the momentum by the frictional force μN is finally conserved. Therefore, the time during which the frictional force μN is exerted in the + direction and the time during which the frictional force μN is exerted in the − direction in one cycle should become the same. In other words, in a case of being viewed in one cycle, it can be seen from the above equations (2) and (3) that the object to be driven 106 moves at the constant velocity v₁₀₆ (in the longitudinal direction of the driving member 102) in such a way that the time t1 where v₁₀₂−v₁₀₆≧0 and the time t2 where v₁₀₂−v₁₀₆<0 are equal (see FIG. 4A(B)). t1 is the time during which a positive frictional force is exerted on the object to be driven 106 and t2 is the time during which a negative frictional force is exerted on the object to be driven 106.

This idea is a theory that the object to be driven 106 (the engagement member 103) slides with respect to the driving member 102 in both periods when the velocity of the driving member 102 is high and when the velocity of the driving member 102 is low. In a case where the times t1 and t2 are not equal, the object to be driven 106 is fixed to the driving member 102. Generally, high velocity v₁₀₆ can be better achieved by following the theory of sliding at both times t1 and t2 since the object to be driven 106 can be given a large acceleration a₁₀₆. Therefore, the description below will be given on the basis of the theory of sliding at both times t1 and t2. Furthermore, in a case where a load such as gravity is applied to the object to be driven 106, a term of the load is added to the left-hand side of the above equation (2). Therefore, the velocity position at which the momentum is balanced is shifted in the vertical direction accordingly.

In order to increase the velocity v₁₀₆ of the object to be driven 106 as much as possible at which times t1 and t2 are equal, the following three velocity improvement factors (a1) to (a3) are necessary.

(a1) The difference between the time t_{f} during which the driving member 102 is moving fast and the time tₛ during which the driving member 102 is moving slowly is increased as much as possible.

(a2) The maximum velocity (v_{102, p}) of the driving member 102 is increased as much as possible during the time tₛ.

(a3) The time during which the driving member 102 is close to the maximum velocity (v_{102, p}) is increased as much as possible during the time tₛ.

Increasing the difference between the times t_{f} and tₛ as much as possible can correspondingly increase the velocity v₁₀₆ at which the times t1 and t2 become constant. Additionally, even in a case where the difference between the times t_{f} and tₛ is large, the velocity does not increase unless the velocity during tₛ is stabilized (in other words, the displacement of the driving member 103 is preferably a clear sawtooth waveform).

FIGS. 4B(A) and (B) illustrates velocity waveforms of the driving member 102 in a case where the driving member 102 is not displaced with the ideal sawtooth waves. In the case of the velocity waveform of the driving member 102 illustrated in FIG. 4B(A), the maximum velocity (v_{102, p}) during tₛ is high, but the period is too short. As a result, the velocity v₁₀₆ of the object to be driven 106, which is a stable point, is decreased. Furthermore, in the case of the velocity waveform of the driving member 102 illustrated in FIG. 4B(B), the difference between the times t_{f} and tₛ is large, but the maximum velocity (v_{102, p}) of the driving member 102 is low. As a result, the velocity v₁₀₆ of the object to be driven 106, which is a stable point, is decreased.

The ideal sawtooth wave displacement of the driving member 102 is illustrated in FIG. 4A(A). However, the actual driving member 102 is a vibration system indicated in the above equation (1). Therefore, displacement does not occur with the ideal sawtooth waves with which the velocity v₁₀₂ of the driving member 102 becomes constant.

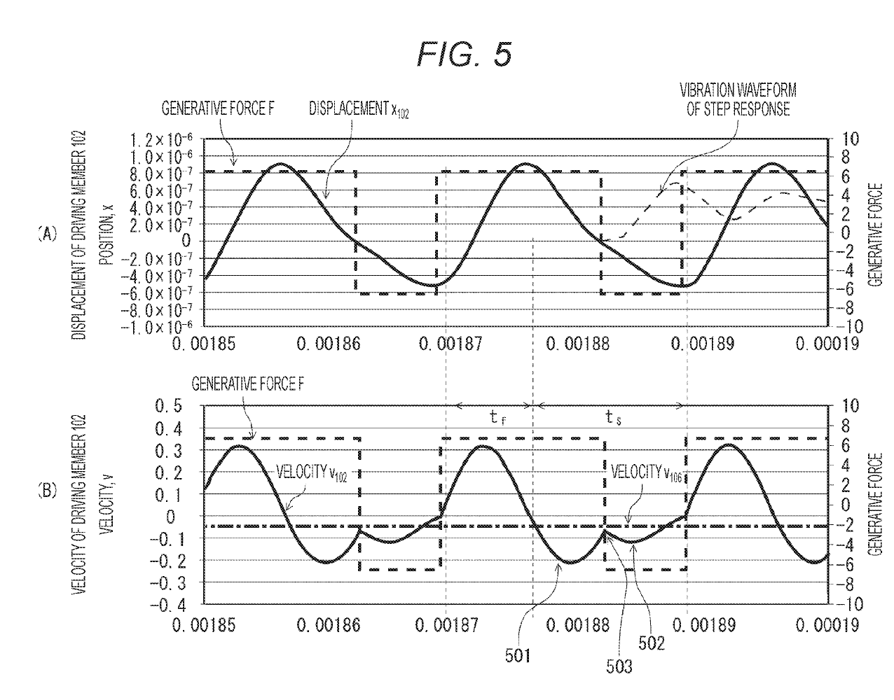

FIGS. 5(A) and (B) illustrate the displacement x₁₀₂ and the velocity v₁₀₂ of the actual driving member 102, respectively, along with the force (generative force) F generated in the piezoelectric element 101 by the driving voltage of the PWM waveform. Note that FIG. 5(B) also illustrates the velocity v₁₀₆ of the object to be driven 106 coupled to the driving member 102 by frictional force. In the examples illustrated in the figures, the waveforms are driving waveforms of the driving member 102 which are intentionally created by solving the above equations (1) to (3). These are cases where the driving circuit 104 illustrated in FIG. 2 is used. By applying a rectangular-wave voltage to the piezoelectric element 101, the driving member 102 exhibits a damped vibration waveform as indicated in the above equation (1). When the voltage application is switched after one cycle of vibration, the driving member 102 moves in the opposite direction. Therefore, the driving member 102 exhibits a sawtooth-wave-shaped displacement as illustrated in FIG. 5(A). At this time, looking at the velocity during the time tₛ that determines the velocity v₁₀₆ of the object to be driven 106, there are two peaks indicated by reference numerals 501 and 502 in the shape. The middle part of the two peaks 501 and 502, which is indicated by reference numeral 503, lowers the balanced position of the velocity as described with reference to FIG. 4B(A). As a result, this becomes a factor of decreasing the velocity v₁₀₆ of the object to be driven 106 in the piezoelectric actuator apparatus 100 using the driving circuit 104 illustrated in FIG. 2.

As a method of improving the velocity decrease of the piezoelectric actuator apparatus 100, it is conceivable to lower the driving frequency of the rectangular-wave voltage applied to the piezoelectric element 101 to increase the time tₛ, for example. However, since the velocity decrease at the antinode 503 illustrated in FIG. 5(B) becomes prominent, the velocity v₁₀₆ of the object to be driven 106 decreases as this is contrary to the velocity improvement factors (a2) and (a3) described above. On the other hand, in a case where the driving frequency of the rectangular-wave voltage is increased and the peaks 501 and 502 are brought close to each other to suppress the velocity decrease at the antinode 503, the time tₛ becomes short this time and the velocity v₁₀₆ of the object to be driven 106 decreases as this is contrary to the velocity improvement factor (a1) described above.

Additionally, according to the velocity improvement factor (a3), it is ideal to match the heights of the peaks 501 and 502 as much as possible, so that the maximum velocity (v_{102, p}) of the driving member 102 can be prolonged. The heights of the peaks 501 and 502 depend on the damping of vibration and frictional force. Since the damping of vibration depends on the physical properties of the piezoelectric element 101 and the mass of the driving member 102, it is not possible to change easily. Adjustment by frictional force requires adjustment of the amplitude by increasing the load according to the above equation (1). Since this results in decrease in overall amplitude and this is contrary to the velocity improvement factor (a2), adjustment by frictional force is not efficient.

Therefore, the piezoelectric actuator apparatus 100 using the driving circuit 104 illustrated in FIG. 2 has an issue in efficient driving since further optimization of the sawtooth wave displacement of the driving member 102 is difficult. In order to achieve high-velocity driving of the object to be driven 106, the size of the piezoelectric element 101 and the generative force and displacement of the piezoelectric element 101 may be increased, but the power consumption increases correspondingly. In a case where the piezoelectric actuator apparatus 100 is used as a driving source of an optical system in a portable apparatus such as an imaging lens of a camera and lenses of a binocular, miniaturization, weight reduction, and reduction in power consumption of the piezoelectric actuator apparatus 100 and the driving circuit 104 are indispensable.

Therefore, there is a need for a technology for inducing optimum sawtooth wave displacement of the driving member 102 without increasing the size of the piezoelectric actuator apparatus 100, and achieving high velocity and low power consumption driving.

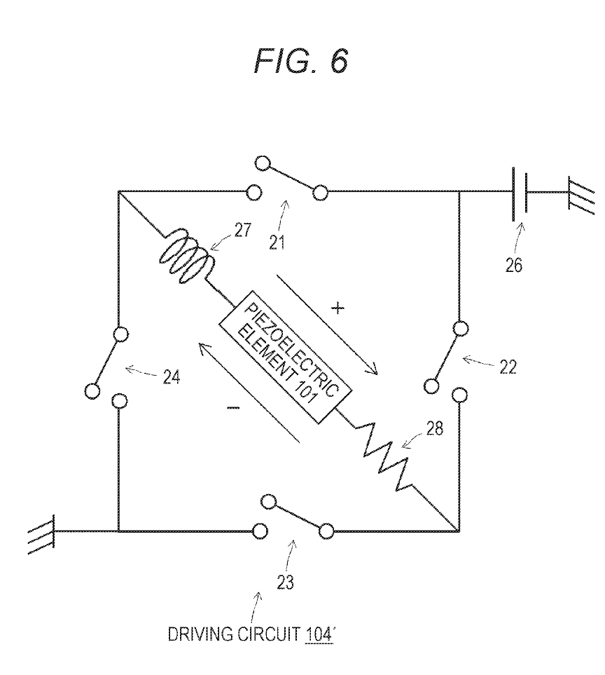

FIG. 6 illustrates a driving circuit 104′ according to another exemplary configuration that inputs a driving voltage to the piezoelectric element 101. A difference from the driving circuit 104 illustrated in FIG. 2 is that an inductor 27 and a resistor 28 are connected in series to both ends of the piezoelectric element 101. A driving control circuit which is not illustrated controls the switching operations of the switches 21 to 24.

Note that the inductor 27 and the resistor 28 are not necessarily circuit parts such as an inductor element and a resistance element. For example, an internal inductance and an internal resistance can be used to configure the inductor 27 and the resistor 28. Alternatively, a combined inductance and a combined resistance may be used to configure a circuit equivalent to that illustrated in FIG. 6.

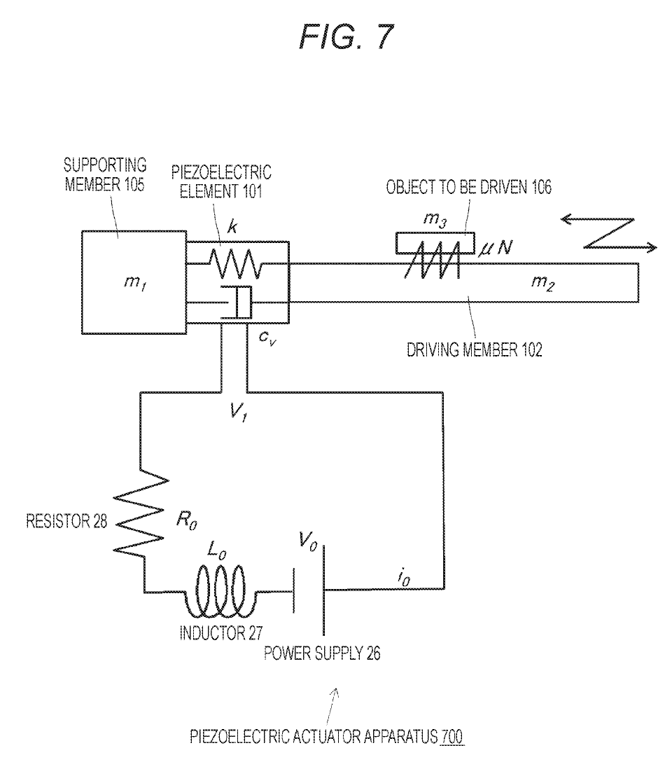

A governing equation of the piezoelectric actuator apparatus 100 will be described. This is the case where the driving circuit 104′ illustrated in FIG. 6 is used. FIG. 7 illustrates a mechanical model of a piezoelectric actuator apparatus 700 using the driving circuit 104′ illustrated in FIG. 6, together with an equivalent circuit of the driving circuit 104′ (note that the same members as those of the piezoelectric actuator apparatus 100 illustrated in FIG. 1 are denoted by the same reference numerals). The definition of each physical property is also described in this figure. R₀ is a resistance value of the resistor 28. Lois an inductance of the inductor 27. V₀ is an applied voltage of the power supply 26. V₁ is a voltage between the terminals of the piezoelectric element 101. i₀ is a current value flowing through the driving circuit 104′.

Here, for the sake of approximation, the supporting member 105 is sufficiently larger than the driving member 102. The mass of the piezoelectric element 101 is sufficiently small. The generative force applied to the piezoelectric element 101 is applied to the driving member 102. In addition, the driving member 102 is a rigid body having the mass m₂. In addition, the mechanical and electrical loads other than those illustrated in FIG. 7 are ignored. It should be noted that since there are other loads and elastic deformation of the driving member 102 in practice, the system becomes more complicated than the one described below.

The piezoelectric element 101 is a device that performs mutual conversion between electricity<->mechanical. It is known that the relationship between the electrical response and the mechanical response of the piezoelectric element 101 is governed by the following piezoelectric equations (4) and (5). Note that S is a strain of the piezoelectric element 101. s^{E} is a compliance of the piezoelectric element 101. T is a stress generated in (or applied to) the piezoelectric element 101. d is a piezoelectric constant. E is an electric field. In addition, D is an electric flux density, and ε^{T} is a permittivity of the piezoelectric element 101.

[Math. 4]

S=s^{E}T+dE (4)

[Math. 5]

D=dT+ε_{T}E (5)

Considering a case where the piezoelectric element 101 is of a multilayer type, E, S, D, and T can be each defined as in the following equation (6). Note that q is a charge, Aₚ is a cross-sectional area of the piezoelectric element 101, and l is the thickness of one layer of the piezoelectric element 101.

$$\begin{matrix}[ Math . 6 ] & \\ E = \frac{{V}_{1}}{l} , S = \frac{{l}_{p}}{nl} , D = \frac{q}{{nA}_{p}} , T = \frac{F}{{A}_{p}} & ( 6 )\end{matrix}$$

The piezoelectric element 101 in the unloaded state deforms according to the piezoelectric constant d [m/V]. Accordingly, the generative force F₀ of the piezoelectric element 101 can be defined as the following equation (7).

$$\begin{matrix}[ Math . 7 ] & \\ {F}_{0} = \frac{{A}_{p} d}{{s}^{E} l} {V}_{1} & ( 7 )\end{matrix}$$

Therefore, the above equation (4) is as indicated in the following equation (8) according to the above equations (6) and (7). Note that n is the number of layers in the piezoelectric element 101, and lₚ is displacement of the piezoelectric element 101.

$$\begin{matrix}[ Math . 8 ] & \\ \frac{{A}_{p}}{{nls}^{E}} {l}_{p} = F + {F}_{0} & ( 8 )\end{matrix}$$

The above equation (8) means that addition of the load F to the generative force F₀ in applying a voltage to the piezoelectric element 101 yields the actual displacement lₚ of the piezoelectric element 101. In many cases, displacement of the actual piezoelectric element 101 differs from a theoretical value calculated from the piezoelectric constant d. This is due to a load in a portion which does not have electrodes or the like in the case of a multilayer type, for example. The actual displacement lₚ at the stationary state at this time is defined as the following equation (9).

$$\begin{matrix}[ Math . 9 ] & \\ {l}_{p} = \frac{{F}_{0}}{k} & ( 9 )\end{matrix}$$

In a transient response of the piezoelectric actuator apparatus 700 illustrated in FIG. 7, the acceleration of the driving member 102, the damping of the piezoelectric element 101, and the frictional force with respect to the object to be driven 106 are loads to the piezoelectric element 101. Therefore, the force F in the above equation (8) can be considered as the following equation (10).

$$\begin{matrix}[ Math . 10 ] & \\ F = ( \frac{{A}_{p}}{{nls}^{E}} - k ) {l}_{p} - {c}_{v} \frac{{dl}_{p}}{dt} - {m}_{2} \frac{{d}^{2} {l}_{p}}{{dt}^{2}} - χ \cdot μ N & ( 10 )\end{matrix}$$

The above equation (8) can derive the following equation (11) from the above equation (10). Here, the spring constant k and the damping coefficient cᵥ are constant values.

$$\begin{matrix}[ Math . 11 ] & \\ {F}_{0} = {kl}_{p} + {c}_{v} \frac{{dl}_{p}}{dt} + {m}_{2} \frac{{d}^{2} {l}_{p}}{{dt}^{2}} + χ \cdot μ N & ( 11 )\end{matrix}$$

Next, solving the above-described piezoelectric equations (4) and (5) as simultaneous equations yields the following equation (12) as indicated below.

$$\begin{matrix}[ Math . 12 ] & \\ D = d \frac{S - dE}{{s}^{E}} + {ɛ}^{T} E & ( 12 )\end{matrix}$$

Transforming the above equation (12) using the above equation (6) yields the following equation (13) as indicated below.

$$\begin{matrix}[ Math . 13 ] & \\ {V}_{1} = \frac{{ls}^{E}}{( {s}^{E} {ɛ}^{T} - {d}^{2} ) {nA}_{p}} q - \frac{d}{( {s}^{E} {ɛ}^{T} - {d}^{2} ) n} {l}_{p} & ( 13 )\end{matrix}$$

A governing equation (14) of the driving circuit 104′ illustrated in FIG. 7 (or FIG. 6) can be derived from the above equation (13)

$$\begin{matrix}[ Math . 14 ] & \\ \begin{matrix}{V}_{0} = {R}_{0} {i}_{0} + {L}_{0} \frac{{di}_{0}}{dt} + {V}_{1} \\ = {R}_{0} {i}_{0} + {L}_{0} \frac{{di}_{0}}{dt} + \frac{{ls}^{E}}{( {s}^{E} {ɛ}^{T} - {d}^{2} ) {nA}_{p}} \int {i}_{0} dt - \frac{d}{( {s}^{E} {ɛ}^{T} - {d}^{2} ) n} {l}_{p}\end{matrix} & ( 14 )\end{matrix}$$

Here, rearranging the above equations (11) and (14) using the following equation (15) respectively yields the following equations (16) and (17) as indicated below.

$$\begin{matrix}[ Math . 15 ] & \\ A = \frac{{dA}_{p}}{{ls}^{E}} , B = \frac{( {s}^{E} {ɛ}^{T} - {d}^{2} ) {nA}_{p}}{{ls}^{E}} , {l}_{p} = {x}_{102} = x & ( 15 ) \\ [ Math . 16 ] & \\ {F}_{0} = kx + {c}_{v} \frac{dx}{dt} + {m}_{2} \frac{{d}^{2} x}{d {t}^{2}} + χ \cdot μ N & ( 16 ) \\ [ Math . 17 ] & \\ {V}_{0} = {R}_{0} \frac{dq}{dt} + {L}_{0} \frac{{d}^{2} q}{{dt}^{2}} + \frac{1}{B} q - \frac{A}{B} x & ( 17 )\end{matrix}$$

By further rearranging the above equations (7), (16) and (17), a fourth-order differential equation is obtained as indicated in the following equation (18).

$$\begin{matrix} [ Math . 18 ] & \\ {V}_{0} = \frac{{L}_{0} {m}_{2} B}{A} \frac{{d}^{4} x}{{dt}^{4}} + ( \frac{{L}_{0} {c}_{v} B + {R}_{0} {m}_{2} B}{A} ) \frac{{d}^{3} x}{{dt}^{3}} + ( \frac{{L}_{0} {A}^{2} + {L}_{0} kB + {R}_{0} {c}_{v} B + {m}_{2}}{A} ) \frac{{d}^{2} x}{{dt}^{2}} + ( \frac{{R}_{0} {A}^{2} + {R}_{0} kB + {c}_{v}}{A} ) \frac{dx}{dt} + \frac{k}{A} x + χ \cdot \frac{μ N}{A} & ( 18 )\end{matrix}$$

The above equation (18) is a governing equation of the piezoelectric actuator apparatus 700 illustrated in FIG. 7. That is, the displacement x of the driving member 102 with respect to the driving voltage V₀ applied to the piezoelectric element 101 is governed by the fourth-order differential equation (18). As described later, this governing equation (18) forms two second-order vibration waveforms having two resonance points. Not only can two resonance frequencies (fₙ₁, fₙ₂) be obtained by analytical solutions, but also actual measurement can be done.

Furthermore, it can be seen that assuming L₀=0 and R₀=0, the same equation as the above equation (1) can be obtained from the governing equation (18) described above. Therefore, because of the new configuration (see FIGS. 6 and 7) in which a driving voltage is applied to the piezoelectric element 101 to which the inductor 27 and the resistor 28 are connected in series, the governing equation of the piezoelectric actuator apparatus 700 becomes the fourth-order differential equation (18) (of displacement x of the driving member 102) described above and the two resonance phenomena appear.

Furthermore, in the case of a governing equation for the driving unit 107 including the supporting member 105, the piezoelectric element 101, and the driving member 102, the frictional force term is not taken into account. Therefore, the equation is as indicated in the following equation (19)

$$\begin{matrix} [ Math . 19 ] & \\ {V}_{0} = \frac{{L}_{0} {m}_{2} B}{A} \frac{{d}^{4} x}{{dt}^{4}} + ( \frac{{L}_{0} {c}_{v} B + {R}_{0} {m}_{2} B}{A} ) \frac{{d}^{3} x}{{dt}^{3}} + ( \frac{{L}_{0} {A}^{2} + {L}_{0} kB + {R}_{0} {c}_{v} B + {m}_{2}}{A} ) \frac{{d}^{2} x}{{dt}^{2}} + ( \frac{{R}_{0} {A}^{2} + {R}_{0} kB + {c}_{v}}{A} ) \frac{dx}{dt} + \frac{k}{A} x & ( 19 )\end{matrix}$$

Hereinafter, the resonance frequencies of the piezoelectric actuator apparatus 700 will be mainly described. Since the frictional force term is a constant value and becomes a load to a response of the driving member 102, the frictional force term affects the amplitude, but it is possible not to affect the resonances of a frequency response and a step response as well as the waveform shape. Therefore, the following description will be given on the basis of the above equation (19) which does not include the frictional force term.

Next, the frequency response of the piezoelectric actuator apparatus 700 illustrated in FIG. 7 will be described.

Since each coefficient of the above equation (19) is a constant obtained by combining physical property values, generalization is made as in the following equation (20).

$$\begin{matrix}[ Math . 20 ] & \\ {V}_{0} = a \frac{{d}^{4} x}{{dt}^{4}} + b \frac{{d}^{3} x}{{dt}^{3}} + c \frac{{d}^{2} x}{{dt}^{2}} + h \frac{dx}{dt} + px & ( 20 )\end{matrix}$$

Laplace-transforming the above equation (20) yields the following equation (21) as indicated below. Furthermore, the transfer function P(s) can be expressed by the following equation (22).

$$\begin{matrix}[ Math . 21 ] & \\ V ( s ) = ( {as}^{4} + {bs}^{3} + {cs}^{2} + hs + p ) X ( s ) & ( 21 ) \\ [ Math . 22 ] & \\ P ( s ) = \frac{1}{{as}^{4} + {bs}^{3} + {cs}^{2} + hs + p} & ( 22 )\end{matrix}$$

The following quartic equation (23) where the denominator of the above equation (22)=0 can solve a general solution by (publicly known) Ferrari's law. The general solution is as indicated in the following equation (24). Note that γ₁ and γ₂ are real terms of the quartic equation, and δ₁ and δ₂ are imaginary terms of the quartic equation.

[Math. 23]

as⁴+bs³+cs²+hs+p=0 (23)

[Math. 24]

s=γ₁±jδ₁, γ₂±jδ₂ (24)

In addition, in a case where the solution of s is not the above equation (24) and the imaginary solutions are not taken, the resonance vibration which is the principle of the piezoelectric actuator apparatus 700 cannot be used. Therefore, the effect cannot be exhibited.

From the above equation (24), the transfer function P(s) in the above equation (22) can be transformed as in the following equation (25). Note that ωₙ₁ and ωₙ₂ are the natural circular frequencies of this system, and ζ₁ and ζ₂ are the damping ratios of this system.

$$\begin{matrix}[ Math . 25 ] & \\ P ( s ) = \frac{1}{{s}^{2} + 2 {ζ}_{1} {ω}_{n 1} s + {ω}_{n 1}^{2}} \cdot \frac{1}{{s}^{2} + 2 {ζ}_{2} {ω}_{n 2} s + {ω}_{n 2}^{2}} \\ {ω}_{n 1} = \sqrt{{γ}_{1}^{2} + {δ}_{1}^{2}} , {ζ}_{1} = - \frac{{γ}_{1}}{{ω}_{n 1}} \\ {ω}_{n 2} = \sqrt{{γ}_{2}^{2} + {δ}_{2}^{2}} , {ζ}_{2} = - \frac{{γ}_{2}}{{ω}_{n 2}} & ( 25 )\end{matrix}$$

It can be seen from the above equation (25) that the piezoelectric actuator apparatus 700 is a multiplication of the secondary system. A frequency response to a sinusoidal input of the piezoelectric actuator apparatus 700 can be expressed by a gain |P(jω)| and a phase delay ∠P(jω). The gain is as indicated in the following equations (26) and (27)

$$\begin{matrix} [ Math . 26 ] & \\ \vert P ( j ω ) \vert = \frac{1}{{ω}_{n 1}^{2} \sqrt{{( 1 - {( \frac{ω}{{ω}_{n 1}} )}^{2} )}^{2} + {( 2 {ζ}_{1} \frac{ω}{{ω}_{n 1}} )}^{2}}} \cdot \frac{1}{{ω}_{n 2}^{2} \sqrt{{( 1 - {( \frac{ω}{{ω}_{n 2}} )}^{2} )}^{2} + {( 2 {ζ}_{2} \frac{ω}{{ω}_{n 2}} )}^{2}}} & ( 26 ) \\ [ Math . 27 ] & \\ 20 log \text{?} ( \vert P ( j ω ) \vert ) = 20 log \text{?} ( \frac{1}{{ω}_{n 1}^{2} \sqrt{{( 1 - {( \frac{ω}{{ω}_{n 1}} )}^{2} )}^{2} + {( 2 {ζ}_{1} \frac{ω}{{ω}_{n 1}} )}^{2}}} ) + 20 log \text{?} ( \frac{1}{{ω}_{n 2}^{2} \sqrt{{( 1 - {( \frac{ω}{{ω}_{n 2}} )}^{2} )}^{2} + {( 2 {ζ}_{2} \frac{ω}{{ω}_{n 2}} )}^{2}}} ) & ( 27 ) \\ \text{?} \text{indicates text missing or illegible when filed} & \end{matrix}$$

In the piezoelectric actuator apparatus 700 illustrated in FIG. 7, therefore, the response is the addition of the two gain characteristics of the secondary system.

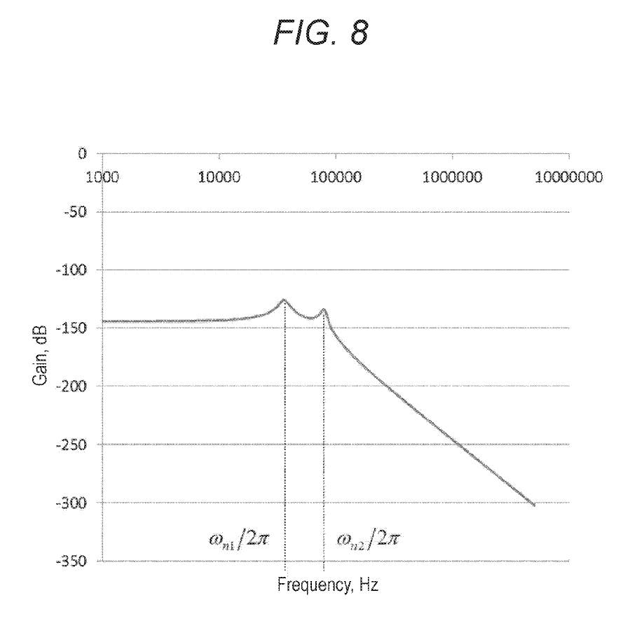

FIG. 8 illustrates an example of the frequency response of the transfer function indicated in the above equation (22). As illustrated in this figure, it can be seen that the system has two resonance frequencies ωₙ₁/2π (=fₙ₁) and ωₙ₂/2π (=fₙ₂). These resonance frequencies fₙ₁ and fₙ₂ can be derived as analytical solutions by solving the quartic equation indicated in the above equation (22) where the denominator of the transfer function=0.

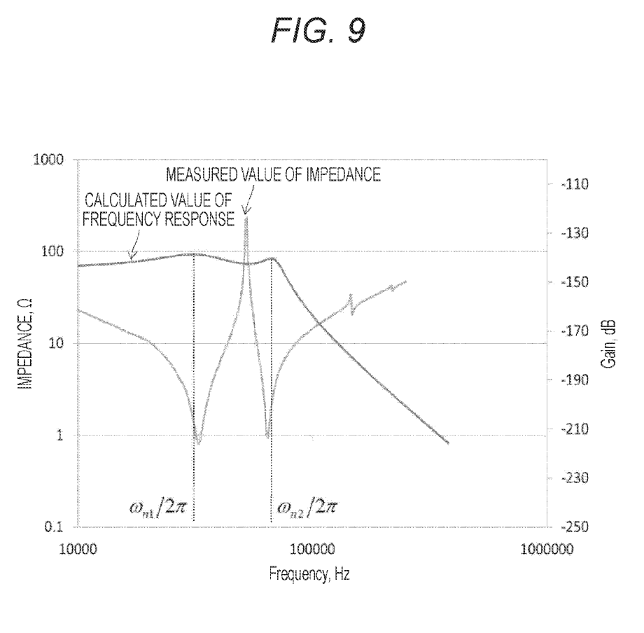

In an actual measurement, the two resonance frequencies can be easily measured by taking an impedance characteristic of the driving unit 107. FIG. 9 exemplifies a comparison between an actual measured value of the impedance characteristic of the driving unit 107 and a calculated value of the frequency response obtained from the above equation (22). Because of the influence of the resonance characteristics of the driving member 102 and the supporting member 105 which are not taken into account in the above theoretical equation, the frequency is slightly different in the actual measurement. However, it can be seen that the minimal values of the impedance characteristic are approximately equal to ωₙ₁/2π and ωₙ₂/2π indicated in the above equation (25).

One resonance frequency fₙ₁ (where fₙ₁<fₙ₂) is a mechanical resonance whose frequency decreases due to the electrical influence by the piezoelectric effect of the piezoelectric element 101. The resonance frequency fₙ₁ (where fₙ₁<fₙ₂) is smaller than the resonance frequency (√k/m₂) of a two-mass system, and is mainly composed of a mechanical resonance frequency of the piezoelectric actuator apparatus 700. A simple “mechanical resonance” is mainly a mechanical resonance of the driving unit 107 of the piezoelectric actuator apparatus 700. Along with this mechanical resonance, the above-described resonance phenomenon receives the influence of the electric circuit of the piezoelectric actuator apparatus 700 due to the piezoelectric effect of the piezoelectric element 101. Such a resonance phenomenon is hereinafter referred to as “piezoelectric mechanical resonance”.

In addition, the other resonance frequency fₙ₂ (where fₙ₁<fₙ₂) is an electrical resonance whose frequency increases due to the mechanical influence by the piezoelectric effect of the piezoelectric element 101. The resonance frequency fₙ₂ (where fₙ₁<fₙ₂) is larger than the resonance frequency (√1/L₀C₀) of the LCR circuit, and is mainly composed of an electrical resonance frequency. Note that L₀ indicates an inductance of the inductor 27 connected in series to the piezoelectric element 101 in the driving circuit 104′, and C₀ indicates a capacitance calculated from the physical property values of the piezoelectric element 101. A simple “electrical resonance” is mainly a resonance in the electric circuit of the piezoelectric actuator apparatus 700. Along with this electrical resonance, the above-described resonance phenomenon receives the influence of the mechanical vibration of the piezoelectric actuator apparatus 700 (driving unit 107) due to the piezoelectric effect of the piezoelectric element 101. Such a resonance phenomenon is hereinafter referred to as “piezoelectric electrical resonance”.

When a rectangular-wave voltage is applied to the piezoelectric element 101, the piezoelectric actuator apparatus 700 illustrated in FIG. 7 displaces the driving member 102 by using the resonance phenomenon in which the piezoelectric mechanical resonance and the piezoelectric electrical resonance described above are mutually related.

Each of the natural circular frequencies ωₙ₁ and ωₙ₂ is a function of k, cᵥ, m₂, L₀, C₀, and R₀, and is a value that changes regardless of which physical property value changes among them. As described above, it can be said that the piezoelectric actuator apparatus 700 illustrated in FIG. 7 is an apparatus in which the piezoelectric electrical resonance and the piezoelectric mechanical resonance due to the piezoelectric effect are mutually related. Such an interactive resonance phenomenon occurs due to the new configuration (see FIG. 6 or FIG. 7) where a driving voltage is applied to the piezoelectric element 101 to which the inductor 27 and the resistor 28 are connected in series.

Next, the response of the piezoelectric actuator apparatus 700 illustrated in FIG. 7 will be described.

The response of the driving member 102 when a rectangular-wave voltage is actually applied to the piezoelectric element 101 is considered. According to the above equation (20), if x=e^{λt}, the following equation (28) is obtained as indicated below. Note that λ is a characteristic solution of the differential equation. The characteristic equation for this case is the following equation (29).

[Math. 28]

V₀=aλ⁴+bλ³+cλ²+hλ+p)e^{λt} (28)

[Math. 29]

aλ⁴+bλ³+cλ²+hλ+p=0 (29)

Since the above equation (29) is the same as the above equation (23), the solution thereof is as indicated in the following equation (30).

[Math. 30]

λ=γ₁±jδ₁, γ₂±jδ₂ (30)

Therefore, the general solution of the above equation (28) becomes the following equation (31). Note that Cₛ, Dₛ, Eₛ, and Fₛ are coefficients of the general solution of the differential equation.

[Math. 31]

x=e^{γ}^{₁}^{t}(Cₛ cos δ₁t+Dₛ sin δ₁t)+e^{γ}^{₂}^{t}(Eₛ cos δ₂t+Fₛ sin δ₂t) (31)

In a case where the above equation (30) does not result in imaginary solutions, the resonance vibration which is the principle of the piezoelectric actuator apparatus 700 cannot be used. Therefore, the effect cannot be exhibited.

In the case of considering rectangular-wave driving, the initial condition may be set as in the following equation (32).

$$\begin{matrix}[ Math . 32 ] & \\ \{ \begin{matrix}x ( 0 ) = - ( K - {x}_{0} ) = - ( {AV}_{0} / k - {x}_{0} ) \\ \dot{x} ( 0 ) = {v}_{0} , \ddot{x} ( 0 ) = {a}_{0} , {x}^{…} ( 0 ) = {j}_{0}\end{matrix} & ( 32 )\end{matrix}$$

Therefore, the coefficients Cₛ, Dₛ, Eₛ, and Fₛ of the general solution of the differential equation in the above equation (31) can be derived as in the following equations (33) and (34).

$$\begin{matrix} [ Math . 33 ] & \\ C \text{?} = \frac{( {b}_{2} {c}_{1} / {b}_{1} - {c}_{2} ) ( K - {x}_{0} ) - {b}_{2} / {b}_{1} \cdot {a}_{0} - ( 3 {γ}_{2}^{2} - {δ}_{2}^{2} - 2 {b}_{2} {γ}_{2} / {b}_{1} ) {v}_{0} + {j}_{0}}{{a}_{2} - {b}_{2} {a}_{1} / {b}_{1}} \\ D \text{?} = - \frac{{a}_{1} C \text{?} + {c}_{1} ( K - {x}_{0} ) + 2 {γ}_{2} {v}_{0} - {a}_{0}}{{b}_{1}} \\ E \text{?} = - ( K - {x}_{0} ) - C \text{?} \\ F \text{?} = \frac{{γ}_{2} ( K - {x}_{0} ) - {δ}_{1} D \text{?} + ( {γ}_{2} - {γ}_{1} ) C \text{?} + {v}_{0}}{{δ}_{2}} & ( 33 ) \\ [ Math . 34 ] & \\ {a}_{1} = {γ}_{1}^{2} - {δ}_{1}^{2} + {δ}_{2}^{2} + {γ}_{2}^{2} - 2 {γ}_{1} {γ}_{2} \\ {b}_{1} = 2 {γ}_{1} {δ}_{1} - 2 {γ}_{2} {δ}_{1} \\ {c}_{1} = {δ}_{2}^{2} + {γ}_{2}^{2} \\ {a}_{2} = {γ}_{1}^{3} - 3 {γ}_{1} {δ}_{1}^{2} + 2 {γ}_{2} {δ}_{2}^{2} + 2 {γ}_{2}^{3} - 3 {γ}_{1} {γ}_{2}^{2} + {γ}_{1} {δ}_{2}^{2} \\ {b}_{2} = 3 {γ}_{1}^{2} {δ}_{1} - {δ}_{1}^{3} - 3 {γ}_{2}^{2} {δ}_{1} + {δ}_{1} {δ}_{2}^{2} \\ {c}_{2} = 2 {γ}_{2} {δ}_{2}^{2} + 2 {γ}_{2}^{3} \\ \text{?} \text{indicates text missing or illegible when filed} & ( 34 )\end{matrix}$$

As a result, the rectangular-wave response indicated in the above equation (31) is as indicated in the following equation (35).

[Math. 35]

x=e^{γ}^{₁}^{t}(Cₛ cos δ₁t+Dₛ sin δ₁t)++e^{γ}^{₂}^{t}(Eₛ cos δ₂t+Fₛ sin δ₂t)+K (35)

The above equation (35) can also be expressed as in the following equation (36). Note that ψ₁ and ψ₂ are vibration amplitudes of the differential equation x, φ₁ and φ₂ are vibration phases of the differential equation, and ν₁ and ν₂ are phase conditions of the differential equation, each of which is as indicated in the following equation (37).

$$\begin{matrix}[ Math . 36 ] & \\ x = {ψ}_{1} {e}^{{γ}_{1} t} cos ( {δ}_{1} t - {φ}_{1} ) + {ψ}_{2} {e}^{{γ}_{2} t} cos ( {δ}_{2} t - {φ}_{2} ) + K & ( 36 ) \\ [ Math . 37 ] & \\ {ψ}_{1} = \sqrt{{C}_{s}^{2} + {D}_{s}^{2}} , {φ}_{1} = {tan}^{- 1} \frac{{D}_{s}}{{C}_{s}} + {v}_{1} , \\ {ψ}_{2} = \sqrt{{E}_{s}^{2} + {F}_{s}^{2}} , {φ}_{2} = {tan}^{- 1} \frac{{F}_{s}}{{E}_{s}} + {v}_{2} , \\ {v}_{1} = \{ \begin{matrix}0 , {C}_{s} \geq 0 \\ π , {C}_{s} < 0\end{matrix} , {v}_{2} = \{ \begin{matrix}0 , {E}_{s} \geq 0 \\ π , {E}_{s} < 0\end{matrix} & ( 37 )\end{matrix}$$

The first term on the right-hand side of the equation (36) represents the piezoelectric mechanical resonance, and the second term represents the piezoelectric electrical resonance.

Furthermore, if the above equation (36) is differentiated, the velocity v is as indicated in the following equation (38). Note that ψ₃ and ψ₄ are vibration amplitudes of the differential equation v, φ₃ and φ₄ are vibration phases of the differential equation v, ν₃ and ν₄ are phase conditions of the differential equation v, each of which is as indicated in the following equation (39).

$$\begin{matrix}[ Math . 38 ] & \\ v = {ψ}_{3} {e}^{{γ}_{1} t} cos ( {δ}_{1} t - {φ}_{3} ) + {ψ}_{4} {e}^{{γ}_{2} t} cos ( {δ}_{2} t - {φ}_{4} ) & ( 38 ) \\ [ Math . 39 ] & \\ {ψ}_{3} = {ψ}_{1} \sqrt{{γ}_{1}^{2} + {δ}_{1}^{2}} , {φ}_{3} = {φ}_{1} + {tan}^{- 1} \frac{- {δ}_{1}}{{γ}_{1}} + {v}_{3} , \\ {ψ}_{4} = {ψ}_{2} \sqrt{{γ}_{2}^{2} + {δ}_{2}^{2}} , {φ}_{4} = {φ}_{2} + {tan}^{- 1} \frac{- {δ}_{2}}{{γ}_{2}} + {v}_{4} , \\ {v}_{3} = \{ \begin{matrix}0 , {γ}_{1} \geq 0 \\ π , {γ}_{1} < 0\end{matrix} , {v}_{4} = \{ \begin{matrix}0 , {γ}_{2} \geq 0 \\ π , {γ}_{2} < 0\end{matrix} & ( 39 )\end{matrix}$$

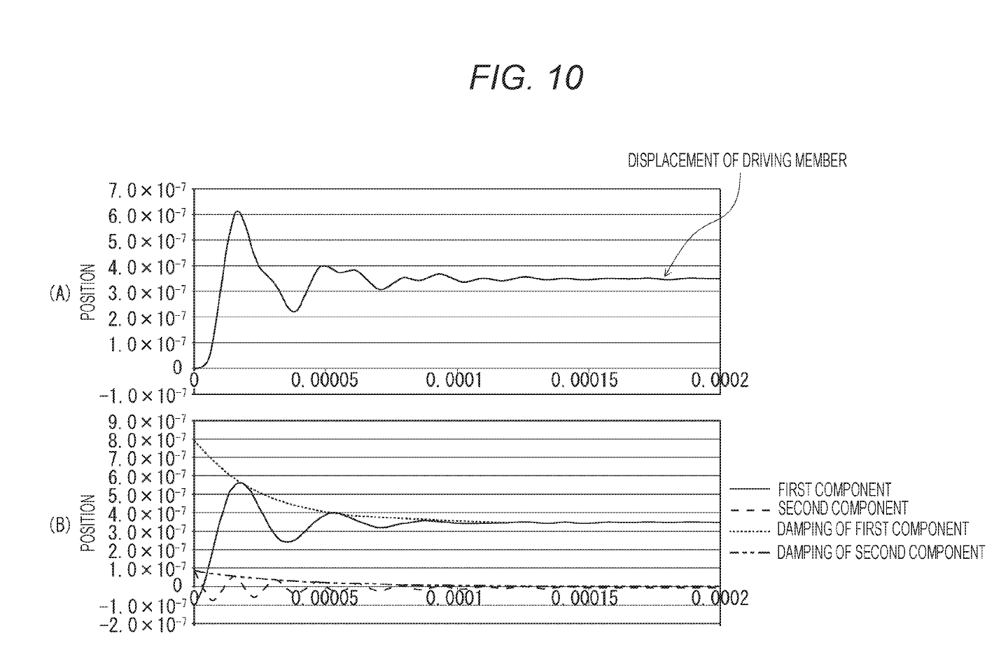

FIG. 10(A) illustrates a step response (displacement of the driving member 102) of the piezoelectric actuator apparatus 700 (see FIG. 7) obtained by the above equation (36). Note that each constant value is set as k=50000000 [N/m], cᵥ=2 [N·s/m], m₂=8×10⁻⁴ [kg], R₀=5 [Ω], L₀=40 [μH], A=3.5, and B=3×10⁻⁷.

In FIG. 10(B), the displacement of the driving member 102 which is separated into a first component and a second component is illustrated along with a damping of each of the components. The first term on the right-hand side of the above equation (36) is the first component and the second term is the second component. The first component corresponds to vibration of the piezoelectric mechanical resonance and has large principal vibration. The second component corresponds to vibration of the piezoelectric electrical resonance and is small vibration. The resonance frequency fₙ₁ of the piezoelectric mechanical resonance is 28.6 kHz, and the resonance frequency fₙ₂ of the piezoelectric electrical resonance is 63.9 kHz. Then, the sum of the first component and the second component, that is, the sum of the vibration of the piezoelectric mechanical resonance and the vibration of the piezoelectric electrical resonance is the step response as the piezoelectric actuator apparatus 700 (that is, the driving member 102) illustrated in FIG. 10(A).

Similarly, the velocity of the piezoelectric actuator apparatus 700 (driving member 102) is also a superposition of the two vibrations according to the above equation (38). In both position and velocity, the angular frequencies of the vibrations are δ₁ and δ₂. From the above equation (25), δ₁ and δ₂ are as in the following equation (40). Therefore, in a case where the damping ratio ζ is small, δ₁ and δ₂ are substantially equal to the natural circular frequencies ωₙ₁ and ωₙ₂, respectively.

[Math. 40]

δ₁=ωₙ₁\sqrt{1−ζ₁²}, δ₂=ωₙ₂\sqrt{1−ζ₂²} (40)

Furthermore, by calculating a subsequent response from the position, velocity, acceleration, and jerk at the switching timing of the applied voltage of the PWM and then further calculating a response to the switching of the PWM from the above equation (36), the response at the time of PWM driving can be derived as an analytical solution.

Furthermore, in a case where the frictional force term is taken into account in the governing equation (18) of the driving member 102 described above, a general solution can be derived even in the case of taking into account the frictional force term. This is achieved by putting the initial condition of the above equation (32) as the following equation (41).

[Math. 41]

x(0)=−(K−x₀)=−{(AV₀−χ·μN)/k−x₀} (41)

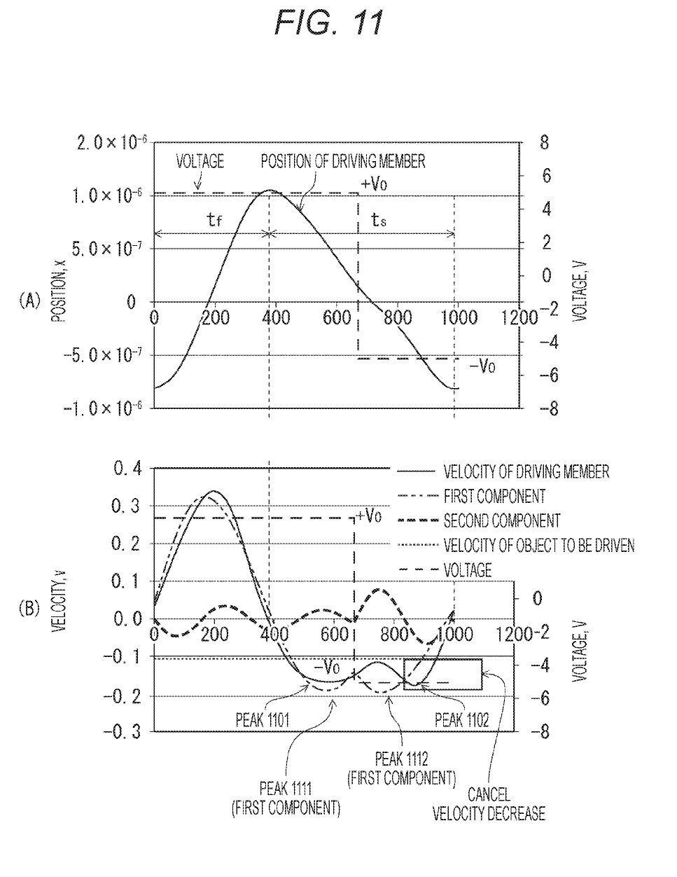

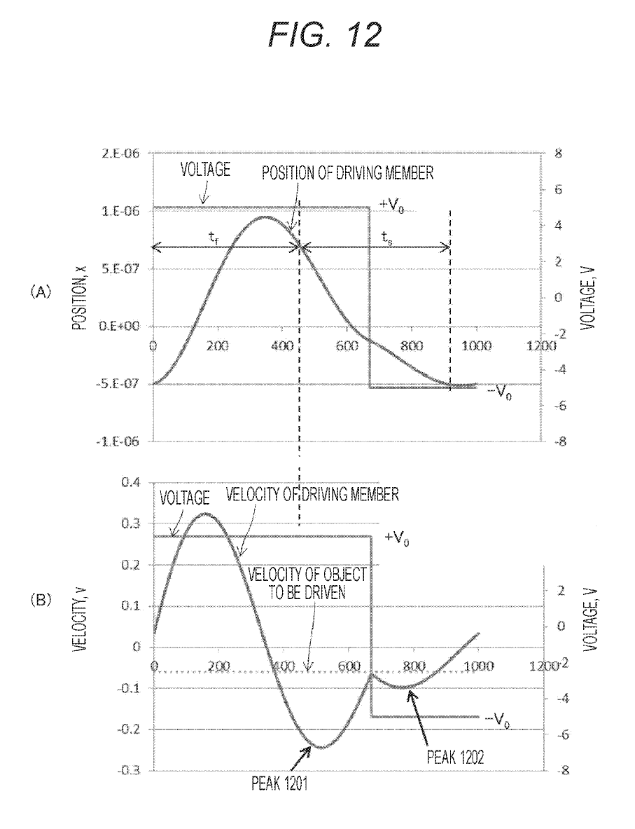

FIGS. 11(A) and (B) illustrate the waveforms of the position and velocity of the driving member 102 in the piezoelectric actuator apparatus 700, respectively, in the case of using the driving circuit 104′ illustrated in FIG. 6. The waveforms illustrated in FIGS. 11(A) and (B) are the analytical solutions of the response waveforms of the piezoelectric actuator apparatus 700 obtained from the above equations (36) and (38). In FIG. 11(B), the velocity of the driving member 120 is the sum of the velocities of the first component and the second component. In comparison with FIGS. 11(A) and (B), furthermore, FIGS. 12(A) and (B) illustrate the waveforms of the position and velocity of the driving member 102 in the piezoelectric actuator apparatus 700, respectively, in the case of using the driving circuit 104 illustrated in FIG. 2. The waveforms illustrated in FIGS. 12(A) and (B) are the analytical solutions of the response waveforms of the piezoelectric actuator apparatus 700 obtained from the above equation (1). The frictional force term is not taken into account. In each figure, the PWM driving frequency and the duty ratio are adjusted so as to be optimum under each condition, and the horizontal axis is normalized by one cycle. Note that each constant value is set as k=20000000 [N/m], c_{c}=8 [N·s/m], m₂=1×10⁻⁴ [kg], R₀=4.5 [Ω], L₀=31 [μH], A=1.3, and B=8×10⁻⁸.

With reference to FIG. 12(B), as described above, the velocity during tₛ which determines the velocity of the object to be driven 106 has a waveform shape including two peaks as indicated by reference numerals 1201 and 1202. In the example illustrated in FIG. 12(B), the height of the peak 1201 and the height of the peak 1202 are not matched, which is a velocity decrease factor. In the case of using the driving circuit 104 illustrated in FIG. 2, adjusting the height of the two peaks is difficult as described above.

By contrast, with reference to FIG. 11(B), the piezoelectric actuator apparatus 700 using the driving circuit 104′ illustrated in FIG. 6 achieves the following (b1) and (b2).

(b1) The heights of two peaks 1101 and 1102 are the same.

(b2) High velocity is maintained for a long time during tₛ.

Comparing the respective waveforms illustrated in FIG. 11(B) and FIG. 12(B), it can be seen that the velocity of the object to be driven 106 at which the velocity is balanced is approximately two times greater in FIG. 11(B). In addition, comparing the change (displacement) of the position of the driving member 102 between FIG. 11(A) and FIG. 12(A), it is more apparent in FIG. 11(A) that both steep displacement (during t_{f}) and moderate displacement (during tₛ) occur at substantially constant velocity (change in slope is small), and the illustrated waveform is clearly close to a sawtooth wave. The above two points (b1) and (b2) depend on the piezoelectric element 101 being driven using the driving circuit 104′ illustrated in FIG. 6. The reason for these points will be described below.

(b1) Concerning the Heights of the Two Peaks being the Same

The damping of the response of the piezoelectric actuator apparatus 700 illustrated in FIG. 7 can be determined by the damping ratios ζ₁ and ζ₂ indicated in the above equation (25). It can be seen from the above equation (19) that both of these damping ratios ζ₁ and ζ₂ are functions of k, cᵥ, m₂, L₀, C₀, and R₀. Therefore, the piezoelectric actuator apparatus 700 illustrated in FIG. 7 can also adjust the vibration of the piezoelectric mechanical resonance, which is the principal vibration, by using not only the damping coefficient cᵥ of the piezoelectric element 101 but also the inductance L₀ and the resistance R₀ connected in series to the piezoelectric element 101. As a result, just by adjusting the respective values of the inductance L₀ and the resistance R₀, the heights of the two peaks 1101 and 1102 can be easily matched as illustrated in FIG. 11(B). This makes it possible to increase the velocity of the object to be driven 106.

(b2) Concerning High Velocity being Maintained for a Long Time During tₛ

As described above, the responses of the position and velocity of the piezoelectric actuator apparatus 700 illustrated in FIG. 7 are the super position of the two vibration waveforms according to the above equations (36) and (38). In FIG. 11(B), the velocity of each of the components, i.e., the first component and the second component, is also illustrated. The first component is the vibration of the piezoelectric mechanical resonance having the angular frequency δ₁, and the second component is the vibration of the piezoelectric electrical resonance having the angular frequency δ₂. Looking only at the first component relating to the piezoelectric mechanical resonance, the waveform has two peaks 1111 and 1112 similarly to FIG. 12(B) (or FIG. 5(b)), whereby maintaining the high velocity of the driving member 102 during tₛ is not possible. As a result, the velocity of the object to be driven 106 cannot be increased. On the other hand, there exists the second component relating to the piezoelectric electrical resonance in the example illustrated in FIG. 11(B). This second component has an effect of canceling the velocity decrease when vibration acts in a direction that offsets the velocity decrease after the second peak 1112 of the first component. As a result, the high velocity of the driving member 102 can be maintained during tₛ, whereby the velocity of the object to be driven 106 can be increased correspondingly.

In other words, the piezoelectric actuator apparatus 700 illustrated in FIG. 7 utilizes the response of the driving member 102 in which the two vibrations of the piezoelectric mechanical resonance and the piezoelectric electrical resonance held by the above equations (36) and (38) are superimposed. That is, the piezoelectric actuator apparatus 700 illustrated in FIG. 7 can control the damping ratios, the amplitudes, and the resonance frequencies of the respective vibrations of the piezoelectric mechanical resonance and the piezoelectric electrical resonance by adjusting the respective values of the inductance L₀ and the resistance R₀ incorporated in the driving circuit 104′. Because of the reasons of the two points (b1) and (b2) described above, therefore, the piezoelectric actuator apparatus 700 optimizes the damping ratios, the amplitudes, and the resonance frequencies of the respective vibrations of the piezoelectric mechanical resonance and the piezoelectric electrical resonance by adjusting the respective values of the inductance L₀ and the resistance R₀. By doing so, the piezoelectric actuator apparatus 700 can induce the response of the driving member 102 which is closer to the sawtooth wave (than using the driving circuit 104 illustrated in FIG. 2), and increase the velocity of the object to be driven 106.

As long as it is possible to use the two resonance phenomena, that is the piezoelectric mechanical resonance and the piezoelectric electrical resonance using the piezoelectric effect where the electricity and the machine mutually interact, the driving circuit 104′ applied to the piezoelectric actuator apparatus 700 is not limited to the configuration illustrated in FIG. 6. Basically, the inductor 27 needs to be connected in series to the piezoelectric element 101. Even if the resistor 28 is not connected in series, the piezoelectric electrical resonance can be used.

Incidentally, in a case where the inductor and the resistor connected in series to the piezoelectric element 101 are connected in parallel, the governing equation does not become a fourth-order but a third-order differential equation, and the two resonance phenomena do not appear. Thus, it is not possible to obtain the effect as illustrated in FIG. 11(B). Furthermore, in a case where either of the inductor and the resistor is connected to the piezoelectric element 101 in parallel, the voltage is not appropriately distributed and thus the desired effect cannot be obtained. As for these modifications of the driving circuit 104, it has been confirmed that the effect cannot be obtained.

There are cases where the velocity cannot be increased even with the piezoelectric actuator apparatus 700 illustrated in FIG. 7, depending on the settings of the respective values of the inductance L₀ and the resistance R₀. Therefore, the following gives bad examples that cannot increase the velocity, and describes a setting method for each of the values of the inductance L₀ and resistance R₀.

As bad examples, the following two points (c1) and (c2) can be given.

(c1) Velocity decrease of the piezoelectric mechanical resonance component cannot be canceled because the frequency of the piezoelectric electrical resonance component is not matched.

(c2) Velocity decrease occurs due to an influence of a too large amplitude of the piezoelectric electrical resonance component.

(c1) Concerning the Inability to Cancel the Velocity Decrease of the Piezoelectric Mechanical Resonance Component Because the Frequency of the Piezoelectric Electrical Resonance Component is not Matched

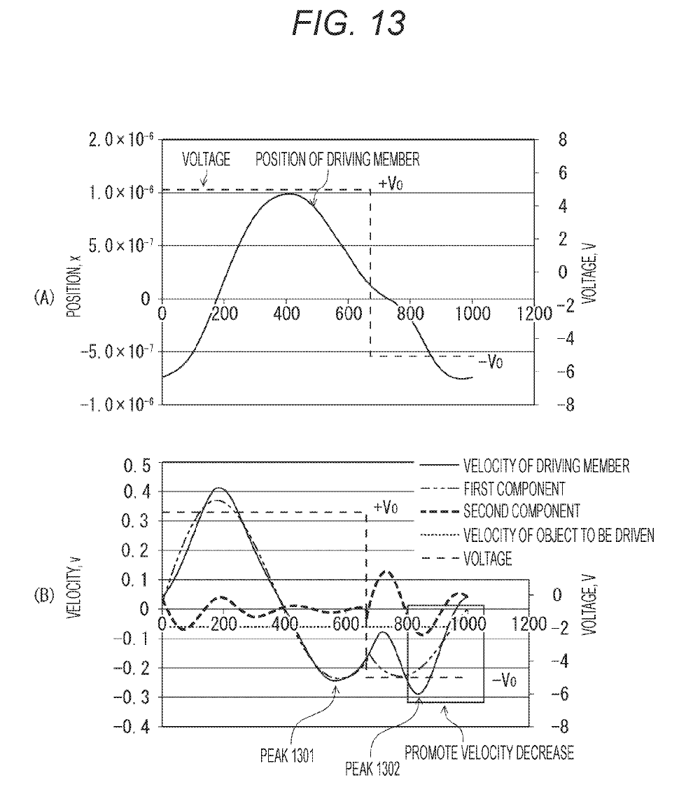

FIGS. 13(A) and (B) respectively illustrate the waveforms of the position and velocity of the driving member 102 in a case where the velocity decrease of the piezoelectric mechanical resonance component cannot be canceled because the frequency of the piezoelectric electrical resonance component is not matched. Note that each constant value is set as k=20000000 [N/m], cᵥ=8 [N·s/m], m₂=1×10⁻⁴ [kg], R₀=7 [Ω], L₀=31 [μH], A=1.3, and B=8×10⁻⁸. Furthermore, the driving frequency of the rectangular-wave driving voltage V₀ is 53.1 [kHz], and the duty ratio thereof is 0.67. In this case, the resonance frequency fₙ₁ of the piezoelectric mechanical resonance (first component) is 67.2 [kHz], and the resonance frequency fₙ₂ of the piezoelectric electrical resonance (second component) is 225.4 [kHz]. As illustrated in FIGS. 13(A) and (B), the piezoelectric mechanical resonance component (first component) of the velocity of the driving member 102 has a waveform having two peaks 1301 and 1302. However, the piezoelectric electrical resonance component (second component) does not cancel the velocity decrease caused by the waveform of the peak 1302 of the piezoelectric mechanical resonance (first component), but rather acts in a direction that promotes the velocity decrease. Therefore, it is not possible to exhibit the effect of canceling the velocity decrease with the piezoelectric electrical resonance component as illustrated in FIG. 11(B).

This is based on the relationship between the respective frequencies δ₁ and δ₂ of the piezoelectric mechanical resonance and the piezoelectric electrical resonance (the relationship between the respective natural circular frequencies ωₙ₁ and ωₙ₂ in a case where the damping ratios are small). Because ωₙ₁/ωₙ₂=approximately 3.3 in the example illustrated in FIGS. 13(A) and (B), the piezoelectric mechanical resonance vibration and the piezoelectric electrical resonance vibration are not superimposed well. That is, unless ωₙ₁/ωₙ₂=approximately 1.5 to 3, the velocity decrease of the piezoelectric mechanical resonance cannot be canceled by the piezoelectric electrical resonance.

(c2) Concerning the Occurrence of the Velocity Decrease Due to the Influence of a Too Large Amplitude of the Piezoelectric Electrical Resonance Component

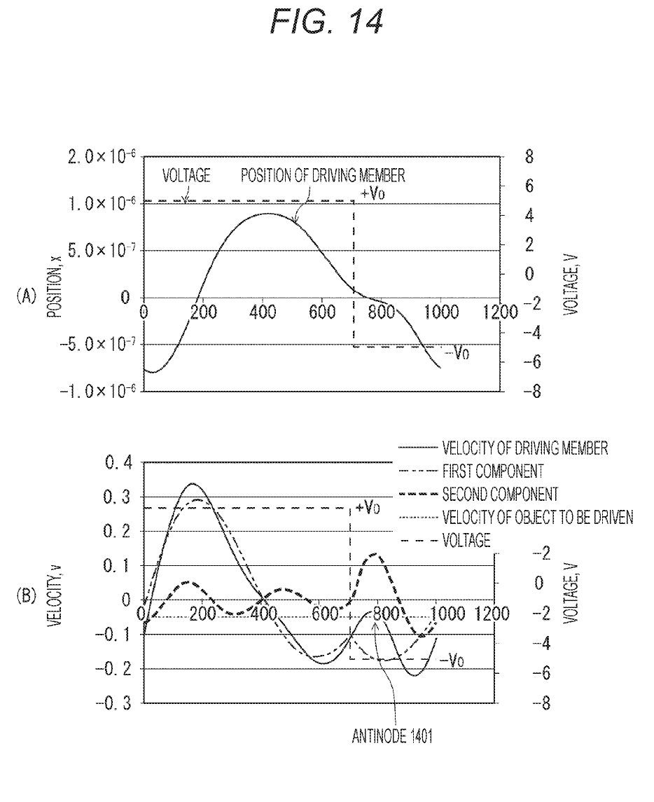

FIGS. 14(A) and (B) respectively illustrate waveforms of the position and the velocity of the driving member 102 in the case of occurrence of the velocity decrease due to the influence of a too large amplitude of the piezoelectric electrical resonance component. Note that each constant value is set as k=20000000 [N/m], cᵥ=8 [N·s/m], m₂=1×10⁻⁴ [kg], R₀=5 [Ω], L₀=30 [μH], A=1.3, and B=8×10⁻⁸. Furthermore, the driving frequency of the rectangular-wave driving voltage V₀ is 43 [kHz], and the duty ratio thereof is 0.71. In this case, the resonance frequency fₙ₁ of the piezoelectric mechanical resonance (first component) is 54.6 [kHz], and the resonance frequency fₙ₂ of the piezoelectric electrical resonance (second component) is 133.9 [kHz]. As illustrated in FIG. 14 (B), the amplitude of the piezoelectric electrical resonance component (second component) is large. In this case, the waveform of the piezoelectric electrical resonance component (second component) can cancel the velocity decrease of the waveform having two peaks of the piezoelectric mechanical resonance (first component), but the decrease at the antinode of the piezoelectric electrical resonance component (second component) becomes prominent. The antinode is indicated by the reference numeral 1401. As a result, the driving member 102 cannot be maintained at high velocity, and the velocity of the object to be driven 106 deteriorates.

In short, in order to exhibit the effect of canceling the velocity decrease with the piezoelectric electrical resonance component as illustrated in FIG. 11(B), it is necessary to appropriately adjust the frequency and the amplitude of the piezoelectric mechanical resonance and the piezoelectric electrical resonance.

Here, settings of the driving frequency of the rectangular-wave driving voltage V₀ applied to the piezoelectric element 101 will be described.

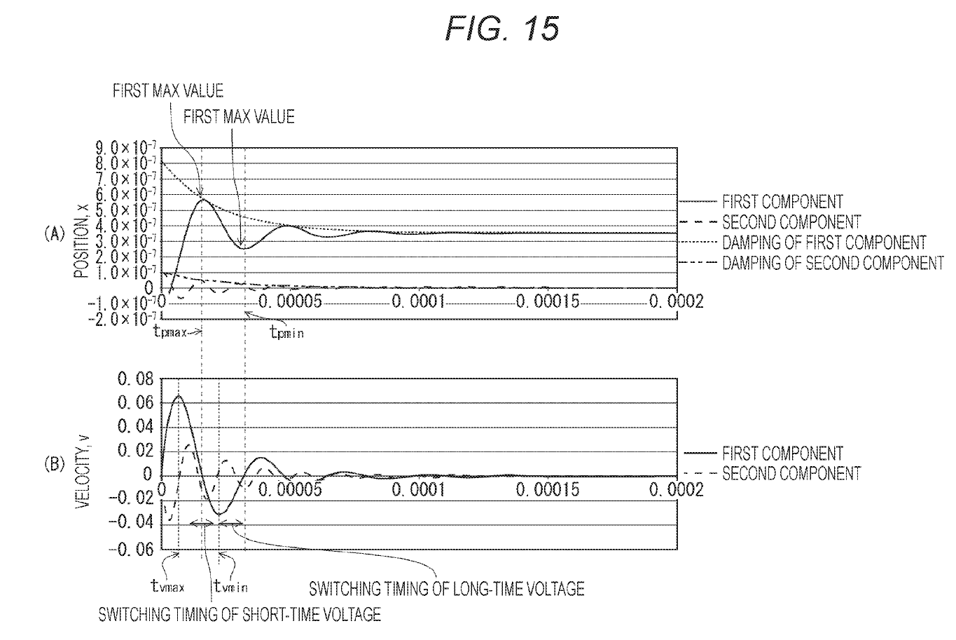

FIGS. 15(A) and (B) respectively illustrate examples of the step response and the velocity of the piezoelectric actuator apparatus 700 (driving member 102) illustrated in FIG. 7, which are decomposed into components of the piezoelectric mechanical resonance vibration and the piezoelectric electrical resonance vibration. Note that the initial velocity, the initial acceleration, and the initial jerk are 0. In addition, each constant value is set as k=50000000 [N/m], cᵥ=2 [N·s/m], m₂=8×10⁻⁴ [kg], R₀=5 [Ω], L₀=28 [μH], A=3.5, and B=3×10⁻⁷. Furthermore, the resonance frequency fₙ₁ of the piezoelectric mechanical resonance (first component) is 31.1 [kHz], and the resonance frequency fₙ₂ of the piezoelectric electrical resonance (second component) is 68.0 [kHz] in this case.

As described above, since the first component (piezoelectric mechanical resonance) is the principal vibration and the second component (piezoelectric electrical resonance) is used as vibration assisting the first component, the focus is on the first component.

In order to exhibit the effect that the second component assists the first component, the waveform is made to have two peaks 1101 and 1102 as illustrated in FIG. 11(B), so that the time tₛ can be increased. For this reason, the driving voltage V₀ needs to be switched in synchronization with the timing of the two peaks 1101 and 1102. Furthermore, to achieve a nearly ideal sawtooth wave displacement of the driving member 102, it is considered to be optimal to perform switching of the opposite driving voltage V₀ at velocity close to 0 so that the velocity distribution switches as linearly as possible.

Each of the time tₚₘₐₓ of the first MAX value and the time tₚₘᵢₙ of the first MIN value of the first component is as indicated in the following equation (42).

$$\begin{matrix}[ Math . 42 ] & \\ {t}_{pma x} = \frac{{φ}_{1}}{{δ}_{1}} , {t}_{pm i n} = \frac{{φ}_{1} + π}{{δ}_{1}} & ( 42 )\end{matrix}$$

At this time, in a case where the damping ratio ζ₁ of the first component is small and the initial velocity, the initial acceleration, and the initial jerk are 0, the following equation (43) can be given from the above equation (25).

$$\begin{matrix}[ Math . 43 ] & \\ {φ}_{1} \approx π , {δ}_{1} \approx {ω}_{n 1} \\ {t}_{pmax} \approx \frac{π}{{ω}_{n 1}} , {t}_{pmin} \approx \frac{2 π}{{ω}_{n 1}} & ( 43 )\end{matrix}$$

As for an actual PWM response, the initial velocity, the initial acceleration, and the initial jerk are not 0 in general. By setting the phase to φₛ, therefore, each of the time tₚₘₐₓ of the first MAX value and the time tₚₘᵢₙ of the first MIN value of the first component is approximated by the following equation (44).

$$\begin{matrix}[ Math . 44 ] & \\ {t}_{pmax} \approx \frac{π + {φ}_{s}}{{ω}_{n 1}} , {t}_{pmin} \approx \frac{2 π + {φ}_{s}}{{ω}_{n 1}} & ( 44 )\end{matrix}$$

Similarly, as for the velocity, in a case where the damping ratio ζ₁ of the first component is small, each of the time tₚₘₐₓ of the first MAX value and the time tₚₘᵢₙ of the first MIN value of the first component is approximated by the following equation (45).

$$\begin{matrix}[ Math . 45 ] & \\ {t}_{vmax} = \frac{{φ}_{3}}{{δ}_{1}} \approx \frac{π / 2 + {φ}_{s}}{{ω}_{n 1}} , {t}_{vmin} = \frac{{φ}_{3} + π}{{δ}_{1}} \approx \frac{3 π / 2 + {φ}_{s}}{{ω}_{n 1}} & ( 45 )\end{matrix}$$

In order to exhibit the effect of canceling the velocity decrease with the piezoelectric electrical resonance component as illustrated in FIG. 11(B), the first component needs to have a waveform including two peaks as described above. Therefore, the switching timing of the voltage (long-time voltage) which applies the driving voltage V₀ with PWM for a long time should be after the MIN value of the velocity (of the driving member 102) and while the velocity is negative. In short, the long-time voltage should be switched in a width between tᵥₘᵢₙ and tₚₘᵢₙ. At this time, since the velocity at the voltage switching timing is negative, the phase φₛ of the short-time voltage is negative.

If it is possible to switch the voltage (short-time voltage) which applies the driving voltage V₀ with PWM for a short time at the position where the velocity is decreasing in FIG. 15(B), the velocity distribution can be switched as linearly as possible, as described above. Therefore, the switching timing of the short-time voltage may be set between tᵥₘₐₓ and tᵥₘᵢₙ so that the velocity becomes 0 as much as possible. If the short-time voltage is applied at this switching timing, the phase φₛ at the subsequent long-time voltage can be either positive or negative, but the phase φₛ of the short-time voltage is considered to be small because the velocity is close to 0. Taking into account the phase φₛ, therefore, it can be said that the long-time voltage and the short-time voltage of the PWM applied voltage V₀ are set as in the following equations (46) and (47), respectively.

$$\begin{matrix}[ Math . 46 ] & \\ LONG \text{-} TIME VOLTAGE \text{:} \\ \frac{3 π / 2}{{ω}_{n 1}} \text{\textasciitilde} \frac{2 π}{{ω}_{n 1}} & ( 46 ) \\ [ Math . 47 ] & \\ S HORT \text{-} TIME VOLTAGE \\ ( TAKING INTO ACCOUNT PHASE {ϕ}_{s} ) \text{:} \\ \frac{π / 2}{{ω}_{n 1}} \text{\textasciitilde} \frac{π}{{ω}_{n 1}} & ( 47 )\end{matrix}$$

Therefore, the cycle T_{d} of the PWM applied voltage V₀ and the driving frequency f_{d} are as indicated in the following equations (48) and (49).

$$\begin{matrix}[ Math . 48 ] & \\ {T}_{d} = \frac{2 π}{{ω}_{n 1}} \text{\textasciitilde} \frac{3 π}{{ω}_{n 1}} & ( 48 ) \\ [ Math . 49 ] & \\ {f}_{d} = \frac{1}{1 \text{\textasciitilde} 1.5} \cdot \frac{{ω}_{n 1}}{2 π} & ( 49 )\end{matrix}$$

It can be seen from the above equation (49) that the driving frequency f_{d} of the PWM applied voltage V₀ should only be set to 1/1.5 to 1 times the resonance frequency fₙ₁ of the piezoelectric mechanical resonance.

Next, the settings of the piezoelectric electrical resonance frequency will be described.

As described above with the bad examples (c1) and (c2) in which the velocity of the piezoelectric actuator apparatus 700 illustrated in FIG. 7 cannot be increased, the piezoelectric electrical resonance frequency can cancel the velocity decrease of the piezoelectric mechanical resonance which is the principal vibration, and the amplitude thereof needs to be sufficiently smaller than that of the piezoelectric mechanical resonance.

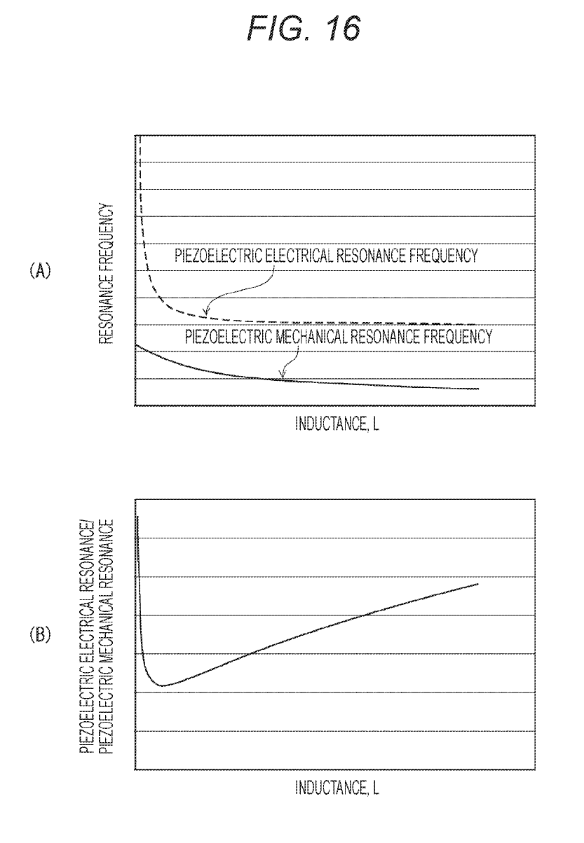

FIG. 16(A) illustrates the piezoelectric mechanical resonance frequency and the piezoelectric electrical resonance frequency with the inductance L₀ of the inductor 27. In addition, FIG. 16(B) illustrates a ratio between the piezoelectric mechanical resonance frequency and the piezoelectric electrical resonance frequency.

As illustrated in FIG. 16(A), as the inductance is increased, the piezoelectric mechanical resonance frequency fₙ₁ decreases without limit. By contrast, it can be seen that the piezoelectric electrical resonance frequency fₙ₂ gradually approaches a certain value along the path. Looking at the ratio between the piezoelectric mechanical resonance frequency and the piezoelectric electrical resonance frequency, it can be seen that the ratio becomes minimum at a certain point and then rises afterward, as illustrated in FIG. 16(B). In order to exhibit the effect of canceling the velocity decrease with the piezoelectric electrical resonance component as illustrated in FIG. 11(B), the relationship between the piezoelectric electrical resonance frequency fₙ₂ and the piezoelectric mechanical resonance frequency fₙ₁ is preferably such that the ratio of both frequencies fₙ₁/fₙ₂ is approximately 1.5 to 3 times as described above.

Next, the relationship between the amplitudes of the piezoelectric mechanical resonance and the piezoelectric electrical resonance will be described.

It is necessary that the piezoelectric electrical resonance vibration does not affect the piezoelectric mechanical resonance vibration significantly. Therefore, the amplitude ψ₁ of the piezoelectric mechanical resonance needs to be sufficiently larger than the amplitude ψ₂ of the piezoelectric electrical resonance.

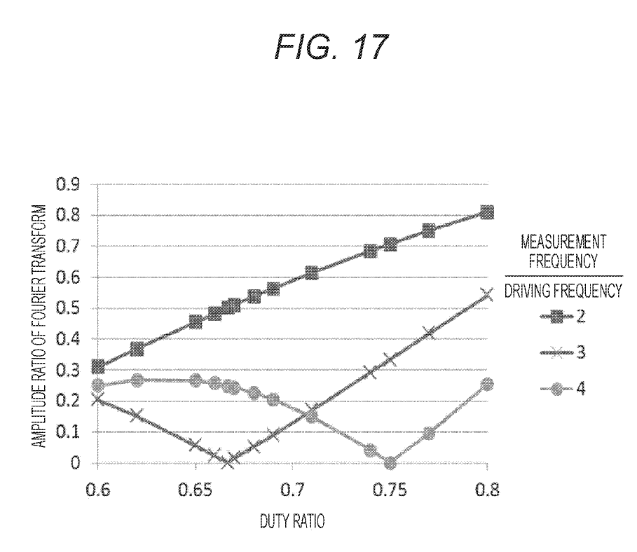

The respective amplitudes ψ₁ and ψ₂ of the piezoelectric mechanical resonance and the piezoelectric electrical resonance are related to the resonance with the PWM voltage which is the input to the piezoelectric element 101. FIG. 17 illustrates the result of the Fourier transform of the PWM voltage. The horizontal axis in this figure is the duty ratio of the long-time voltage. This is confirmed between 0.6 and 0.8. Furthermore, the vertical axis is normalized with the measurement frequency/driving frequency of the Fourier transform=1. As illustrated in FIG. 17, it can be seen that when the duty is two-thirds, the amplitude of the Fourier transform where measurement frequency is three times the driving frequency is 0. Furthermore, it can be seen that when the duty is three-quarters, the amplitude of the Fourier transform where measurement frequency is four times the driving frequency is 0. That is, it can be seen that the frequency with the cycle of the short-time voltage has no amplitude. Furthermore, a driving frequency other than an integral multiple of the driving frequency has no amplitude.

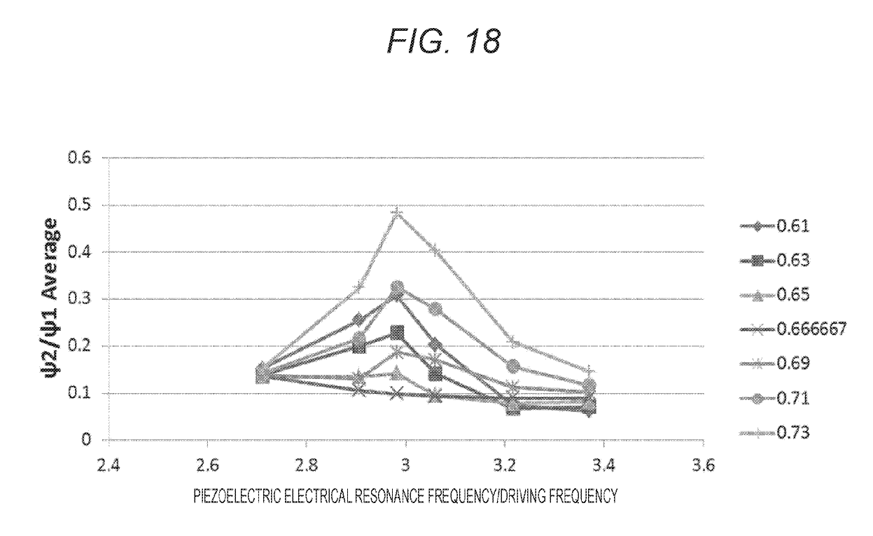

FIG. 18 illustrates the relationship among the duty ratio, the ratio between the amplitude ψ₁ of the piezoelectric mechanical resonance and the amplitude ψ₂ of the piezoelectric electrical resonance, and the frequencies. At the piezoelectric electrical resonance frequency/driving frequency=3, the frequency has an amplitude with the Fourier transform as illustrated in FIG. 17. As illustrated in FIG. 18, the amplitude of the piezoelectric electrical resonance component has a peak of ψ₂/ψ₁ at the piezoelectric electrical resonance frequency/driving frequency=3, and the magnitude thereof correlates with the amplitude of the Fourier transform illustrated in FIG. 17. Furthermore, in a case where the duty ratio is two-thirds, the amplitude of the Fourier transform is 0. Therefore, it can be seen in FIG. 18 that the amplitude does not rise at the position of the piezoelectric electrical resonance frequency/driving frequency=3.

Therefore, the resonance between the PWM driving voltage and the piezoelectric electrical resonance vibration should be avoided in order to suppress the amplitude of the piezoelectric electrical resonance vibration.

To summarize the above, setting within the range of the piezoelectric electrical resonance frequency/driving frequency=1.5 to 4.5 is considered preferable in accordance with the piezoelectric mechanical resonance frequency/driving frequency=1 to 1.5 and the piezoelectric electrical resonance frequency/piezoelectric mechanical resonance frequency=1.5 to 3. Furthermore, by not bringing the piezoelectric electrical resonance frequency close to the frequency having the amplitude with the Fourier transform of the PWM driving voltage within this range, this becomes the range for exhibiting the effect of canceling the velocity decrease with the piezoelectric electrical resonance component as illustrated in FIG. 11(B).

In a case where the above technology disclosed in the present specification is actually applied to the piezoelectric actuator apparatus 700 illustrated in FIG. 7, the piezoelectric mechanical resonance frequency and the piezoelectric electrical resonance frequency may be observed by acquiring an impedance waveform, and the inductance L₀ of the inductor 27 and the resistance value R₀ of the resistor 28 may be adjusted so as to fall within the above range.

Furthermore, in a case where all of the physical properties and the like of the piezoelectric element 101 are apparent, it is possible to derive optimum solutions of the inductance L₀ and the resistance value R₀ more precisely. This is achieved by deriving analytical solutions of the resonance frequencies and the PWM response from the above equations (25), (36), and (38), and performing optimization so as to increase the peak velocity of the driving member 102 with the damping ratio of the piezoelectric mechanical resonance component being approximately 0.1 to 0.15. By taking into account the frictional force term, furthermore, a more precise solution including the precise velocity of the driven member can be obtained.

In short, the displacement of the driving member 102 can be induced with the optimal sawtooth waves just by changing the inductance value L₀ of the inductor 27 and the resistance value R₀ of the resistor 28 connected in series to piezoelectric element 101 according to the piezoelectric actuator apparatus 700 illustrated in FIG. 7. Then, as the driving member 102 is displaced with the optimum sawtooth waves, the object to be driven 106 which is coupled by a predetermined frictional force can be moved at high velocity.

The piezoelectric actuator apparatus 700 illustrated in FIG. 7 can be implemented just by inserting, as illustrated in FIG. 6, the inductor 27 and the resistor 28 to the piezoelectric element 101 in series in the driving circuit 104 including the switching circuits 21 to 24 as illustrated in FIG. 2. That is, easy implementation of the driving circuit 104′ illustrated in FIG. 6 can contribute to miniaturization and weight reduction of the piezoelectric actuator apparatus 700.

Furthermore, since the velocity of the object to be driven 106 can be increased without changing the shape of the piezoelectric element 101 according to the piezoelectric actuator apparatus 700 illustrated in FIG. 7, the miniaturization and weight reduction of the piezoelectric actuator apparatus 700 can be achieved.

### INDUSTRIAL APPLICABILITY

Hereinafter, the technology disclosed in the present specification has been described in detail with reference to the specific embodiment. However, it is apparent that those skilled in the art can make modifications and substitutions of the embodiment without departing from the gist of the technology disclosed in the present specification.

The piezoelectric actuator apparatus according to the technology disclosed in the present specification can be used for adjusting the position of a photographing lens of a camera, adjusting the position of a projection lens of an overhead projector, adjusting the position of lenses of binoculars (alternatively a telescope or a microscope), moving an XY moving state, and the like, for example.

In short, the technology disclosed in the present specification has been described in the form of exemplification, and the description in the present specification should not be taken in a limited sense. In order to determine the gist of the technology disclosed in the present specification, the claims should be taken into consideration.

Note that the technology disclosed in the present specification can be configured as follows.

(1) A piezoelectric actuator apparatus including:

a series connection body in which a piezoelectric element, an inductor, and an electrical resistor are connected in series;

a driving circuit configured to apply a rectangular-wave driving voltage to the series connection body; and

a driving member configured to be driven by the piezoelectric element and couple an object to be driven by a predetermined frictional force.
(2) The piezoelectric actuator apparatus according to (1) above,

in which due to a piezoelectric effect of the piezoelectric element, displacement of the driving member with respect to the driving voltage is governed by a fourth-order differential equation, and a first resonance phenomenon and a second resonance phenomenon derived from the fourth-order differential equation are used for driving.

(3) The piezoelectric actuator apparatus according to (2) above,

in which the first resonance phenomenon is a piezoelectric mechanical resonance mainly including a mechanical resonance of the piezoelectric actuator apparatus with respect to the driving by the piezoelectric element and receiving an electrical influence of the series connection body due to the piezoelectric effect of the piezoelectric element, and

the second resonance phenomenon is a piezoelectric electrical resonance mainly including an electrical resonance and receiving an influence of mechanical vibration of the driving member due to the piezoelectric effect of the piezoelectric element.

(4) The piezoelectric actuator apparatus according to (2) or (3) above,

in which the first resonance phenomenon has a resonance frequency mainly including a mechanical resonance frequency of a two-mass system defined on the basis of an equivalent spring constant determined from a physical property value of the piezoelectric element and a mass of the driving member, and configured to be decreased in receiving the electrical influence due to the piezoelectric effect of the piezoelectric element, and

the second resonance phenomenon has a resonance frequency mainly including an electrical resonance frequency of an LCR circuit defined on the basis of the inductor, the electrical resistor, and a capacitance determined from the physical property value of the piezoelectric element, and configured to be increased in receiving the mechanical influence due to the piezoelectric effect of the piezoelectric element.

(5) The piezoelectric actuator apparatus according to any of (1) to (4) above,

in which an inductance value of the inductor and a resistance value of the electrical resistor are determined so that the resonance frequencies of the first resonance phenomenon and the second resonance phenomenon and damping ratios of resonance vibrations each become desired values.

(6) The piezoelectric actuator apparatus according to any of (1) to (5) above,

in which the inductance value of the inductor and the resistance value of the electrical resistor are determined on the basis of an actual measured value of an impedance characteristic of a driving unit including the piezoelectric element, the driving member, and the object to be driven when the desired first resonance phenomenon and the second resonance phenomenon are obtained.

(7) The piezoelectric actuator apparatus according to (3) above,

in which the inductance value of the inductor and the resistance value of the electrical resistor for making each of the piezoelectric mechanical resonance vibration and the piezoelectric electrical resonance vibration a desired resonance frequency are determined so as to induce a desired sawtooth wave displacement of the driving member with respect to the application of the rectangular-wave driving voltage by superposing the piezoelectric mechanical resonance vibration and the piezoelectric electrical resonance vibration.

(8) The piezoelectric actuator apparatus according to (3) or (7) above,

in which a ratio between the resonance frequency of the piezoelectric mechanical resonance vibration and the resonance frequency of the piezoelectric electrical resonance vibration is in a range of 1.5 to 3.

(9) The piezoelectric actuator apparatus according to (3) or (7) above,

in which a ratio between the resonance frequency of the piezoelectric mechanical resonance vibration and a driving frequency of the rectangular-wave driving voltage is in a range of 1 to 1.5.

(10) The piezoelectric actuator apparatus according to any of (3) and (7) to (9) above,

in which a ratio between the resonance frequency of the piezoelectric electrical resonance vibration and the driving frequency of the rectangular-wave driving voltage is in a range of 1.5 to 4.5.

(11) A control method for a piezoelectric actuator apparatus configured to apply a rectangular-wave driving voltage to a series connection body in which a piezoelectric element, an inductor, and an electrical resistor are connected in series, and drive a driving member by the piezoelectric element, the driving member coupling an object to be driven by a predetermined frictional force, the control method including:

a control step of controlling a rectangular-wave driving frequency of the driving voltage on the basis of one resonance frequency out of two resonance phenomena derived from a fourth-order differential equation, the fourth-order differential equation governing displacement of the driving member with respect to the driving voltage due to a piezoelectric effect of the piezoelectric element.

(12) The control method according to (11) above,

in which in the control step, resonance between the rectangular-wave driving frequency and another resonance vibration of the two resonance phenomena derived from the fourth-order differential equation is avoided.

### REFERENCE SIGNS LIST

100, 700 Piezoelectric actuator apparatus
101 Piezoelectric element
102 Driving member
103 Engagement member
104, 104′ Driving circuit
105 Supporting member
106 Object to be driven

1. A piezoelectric actuator apparatus comprising:
a series connection body in which a piezoelectric element, an inductor, and an electrical resistor are connected in series;
a driving circuit configured to apply a rectangular-wave driving voltage to the series connection body; and
a driving member configured to be driven by the piezoelectric element and couple an object to be driven by a predetermined frictional force.

2. The piezoelectric actuator apparatus according to claim 1,
wherein due to a piezoelectric effect of the piezoelectric element, displacement of the driving member with respect to the driving voltage is governed by a fourth-order differential equation, and a first resonance phenomenon and a second resonance phenomenon derived from the fourth-order differential equation are used for driving.

3. The piezoelectric actuator apparatus according to claim 2,
wherein the first resonance phenomenon is a piezoelectric mechanical resonance mainly including a mechanical resonance of the piezoelectric actuator apparatus with respect to the driving by the piezoelectric element and receiving an electrical influence of the series connection body due to the piezoelectric effect of the piezoelectric element, and
the second resonance phenomenon is a piezoelectric electrical resonance mainly including an electrical resonance and receiving an influence of mechanical vibration of the driving member due to the piezoelectric effect of the piezoelectric element.

4. The piezoelectric actuator apparatus according to claim 2,
wherein the first resonance phenomenon has a resonance frequency mainly including a mechanical resonance frequency of a two-mass system defined on the basis of an equivalent spring constant determined from a physical property value of the piezoelectric element and a mass of the driving member, and configured to be decreased in receiving the electrical influence due to the piezoelectric effect of the piezoelectric element, and
the second resonance phenomenon has a resonance frequency mainly including an electrical resonance frequency of an LCR circuit defined on the basis of the inductor, the electrical resistor, and a capacitance determined from the physical property value of the piezoelectric element, and configured to be increased in receiving the mechanical influence due to the piezoelectric effect of the piezoelectric element.

5. The piezoelectric actuator apparatus according to claim 1,
wherein an inductance value of the inductor and a resistance value of the electrical resistor are determined so that the resonance frequencies of the first resonance phenomenon and the second resonance phenomenon and damping ratios of resonance vibrations each become desired values.

6. The piezoelectric actuator apparatus according to claim 1,
wherein the inductance value of the inductor and the resistance value of the electrical resistor are determined on the basis of an actual measured value of an impedance characteristic of a driving unit including the piezoelectric element, the driving member, and the object to be driven when the desired first resonance phenomenon and the second resonance phenomenon are obtained.

7. The piezoelectric actuator apparatus according to claim 3,
wherein the inductance value of the inductor and the resistance value of the electrical resistor for making each of the piezoelectric mechanical resonance vibration and the piezoelectric electrical resonance vibration a desired resonance frequency are determined so as to induce a desired sawtooth wave displacement of the driving member with respect to the application of the rectangular-wave driving voltage by superposing the piezoelectric mechanical resonance vibration and the piezoelectric electrical resonance vibration.

8. The piezoelectric actuator apparatus according to claim 3,
wherein a ratio between the resonance frequency of the piezoelectric mechanical resonance vibration and the resonance frequency of the piezoelectric electrical resonance vibration is in a range of 1.5 to 3.

9. The piezoelectric actuator apparatus according to claim 3,
wherein a ratio between the resonance frequency of the piezoelectric mechanical resonance vibration and a driving frequency of the rectangular-wave driving voltage is in a range of 1 to 1.5.

10. The piezoelectric actuator apparatus according to claim 3,
wherein a ratio between the resonance frequency of the piezoelectric electrical resonance vibration and the driving frequency of the rectangular-wave driving voltage is in a range of 1.5 to 4.5.

11. A control method for a piezoelectric actuator apparatus configured to apply a rectangular-wave driving voltage to a series connection body in which a piezoelectric element, an inductor, and an electrical resistor are connected in series, and drive a driving member by the piezoelectric element, the driving member coupling an object to be driven by a predetermined frictional force, the control method comprising:
a control step of controlling a rectangular-wave driving frequency of the driving voltage on the basis of one main resonance frequency out of two resonance phenomena derived from a fourth-order differential equation, the fourth-order differential equation governing displacement of the driving member with respect to the driving voltage due to a piezoelectric effect of the piezoelectric element.

12. The control method according to claim 11,
wherein in the control step, resonance between the rectangular-wave driving frequency and another resonance vibration of the two resonance phenomena derived from the fourth-order differential equation is avoided.
